(19) United States
(12) Patent Application Publication
(10) Pub. No.: US 2018/0259775 A1
(43) Pub. Date: Sep. 13, 2018

(54) TRANSMISSION-TYPE DISPLAY DEVICE, DISPLAY CONTROL METHOD, AND COMPUTER PROGRAM

(71) Applicant: SEIKO EPSON CORPORATION, Tokyo (JP)

(72) Inventors: Takehiro Ono, Chino-shi (JP); Yuichi Mori, Minowa-machi (JP)

(73) Assignee: SEIKO EPSON CORPORATION, Tokyo (JP)

(21) Appl. No.: 15/909,554

(22) Filed: Mar. 1, 2018

(30) Foreign Application Priority Data
Mar. 13, 2017 (JP) 2017-047530

(51) Int. Cl. G02B 27/01; G02B 27/00; G06F 3/01; G06F 3/03; G06F 3/0481; G06F 3/0482; G06F 9/44

(52) U.S. Cl. CPC G02B 27/0172; G02B 27/0093; G06F 3/017; G06F 9/44; G06F 3/04817; G06F 3/0482; G06F 3/0325

(57) ABSTRACT

A transmission-type display device includes: a light-transmissive image display unit; a function information acquisition unit which acquires function information of an operation target device; a display control unit which causes an operation GUI of the operation target device to be displayed, using the acquired function information; and an operation detection unit which detects a predetermined gesture of a user of the transmission-type display device. The display control unit causes the operation GUI to be displayed as superimposed on an external field transmitted through the image display unit and visually recognized, at a display position determined according to a position of the detected gesture.

### BACKGROUND

### 1. Technical Field

The present invention relates to a transmission-type display device.

### 2. Related Art

As a head-mounted display device (HMD) which is mounted on the head and displays an image or the like within the range of the field of view of the user, a transmission-type head-mounted display device is known which enables the user to visually recognize an external scene in a see-through manner along with an image when wearing the device. The head-mounted display device guides image light generated, for example, using a liquid crystal display and a light source, to the eyes of the user, using a projection system and a light guide plate or the like, and thereby allows the user to recognize a virtual image. According to the related art, as a measure for the user to control the head-mounted display device, a technique is disclosed in which, when the user puts out a hand in an area where the external scene can be visually recognized in a see-through manner, the user can select, with a fingertip of the hand that is put out, an icon of a button or the like displayed on the liquid crystal display and thus can execute an operation (JP-T-2015-519673).

However, the technique disclosed in JP-T-2015-519673 has a problem that the user needs to place a fingertip accurately on a button. Also, since a desired button needs to be selected from many buttons, the problem of low operability may arise. Moreover, if many buttons are displayed, there may be a problem that the field of vision of the user is blocked, thus causing poor convenience. Such problems are not limited to the transmission-type head-mounted display device and but also occur with a transmission-type display device which displays an image as superimposed on an external scene. Thus, a technique which improves operability when the user controls the transmission-type display device and thus improves convenience for the user is desired.

### SUMMARY

An advantage of some aspects of the invention is to solve at least a part of the problems described above, and the invention can be implemented as the following configurations.

(1) According to an aspect of the invention, a transmission-type display device is provided. The transmission-type display device includes: a light-transmissive image display unit; a function information acquisition unit which acquires function information of an operation target device; a display control unit which causes an operation GUI of the operation target device to be displayed, using the acquired function information; and an operation detection unit which detects a predetermined gesture of a user of the transmission-type display device. The display control unit causes the operation GUI to be displayed as superimposed on an external field transmitted through the image display unit and visually recognized, at a display position determined according to a position of the detected gesture.

The transmission-type display device of this configuration includes the display control unit which causes an operation GUI to be displayed, using function information of an operation target device, and the operation detection unit which detects a predetermined gesture of the user of the transmission-type display device. The display control unit causes the operation GUI to be displayed at a display position determined according to the position of the detected gesture. Therefore, the function information of the operation target device can be drawn together on the operation GUI, and the operation GUI can be displayed at the position corresponding to the position of the gesture made by the user. Thus, operability when controlling the display device can be improved and convenience for the user can be improved.

(2) In the transmission-type display device according to the aspect, the display position of the operation GUI may be determined as a relative position to the position of the detected gesture as a reference. With the transmission-type display device of this configuration, the display position of the operation GUI is determined as a relative position to the position of the detected gesture as a reference. Therefore, the operation GUI can be displayed at the position corresponding to the position of the detected gesture, and the user can predict the display position of the operation GUI. Alternatively, the display position of the operation GUI on the image display unit can be adjusted by controlling the position of the gesture.

(3) In the transmission-type display device according to the aspect, the display control unit may cause the operation GUI to be displayed in an area excluding a center part on the image display unit. With the transmission-type display device of this configuration, the operation GUI is displayed in an area excluding a center part on the image display unit. Therefore, the display of the operation GUI can be restrained from blocking the field of vision of the user.

(4) In the transmission-type display device according to the aspect, the display control unit may cause at least one of image, name, and color associated in advance with a function indicated by the acquired function information, to be displayed on the operation GUI. With the transmission-type display device of this configuration, at least one of image, name, and color associated in advance with the function indicated the acquired function information is displayed on the operation GUI. Therefore, the user can easily identify the function information. Thus, convenience for the user can be improved.

(5) In the transmission-type display device according to the aspect, content of an operation on the operation GUI and a gesture of the user may be associated with each other in advance, and the display control unit may execute an operation on the operation GUI according to the detected gesture of the user. With the transmission-type display device of this configuration, an operation on the operation GUI is executed according to a detected gesture of the user. Therefore, the user can execute the content of an operation on the operation GUI by making the gesture associated with the content of the operation on the operation GUI. Thus, convenience for the user can be improved.

(6) In the transmission-type display device according to the aspect, the function information acquisition unit may acquire the function information, triggered by completion of connection between the operation target device and the transmission-type display device. With the transmission-type display device of this configuration, the function information is acquired, triggered by the completion of connection between the operation target device and the transmission-type display device. Therefore, the function information can be acquired more securely.

(7) In the transmission-type display device according to the aspect, the display control unit may cause the operation GUI to be displayed if the detected gesture is a predetermined gesture. With the transmission-type display device of this configuration, the operation GUI is displayed if the detected gesture is a predetermined gesture. Therefore, the operation GUI can be displayed at a timing desired by the user. Thus, convenience for the user can be improved.

(8) In the transmission-type display device according to the aspect, the display control unit may cause the operation GUI to be displayed if a gesture of the user is detected in a display area of the image display unit. With the transmission-type display device of this configuration, the operation GUI is displayed if a gesture of the user is detected in the display area of the image display unit. Therefore, the operation GUI can be restrained from being displayed by detecting an unintended gesture of the user.

(9) In the transmission-type display device according to the aspect, the display control unit may cause information related to the function information to be displayed in an area where the operation GUI is not displayed, in the display area of the image display unit. With the transmission-type display device of this configuration, information related to the function information is displayed in an area where the operation GUI is not displayed, in the display area of the image display unit. Therefore, the user can visually recognize the operation GUI and the information related to the function information simultaneously in the display area. Thus, convenience for the user can be improved.

The invention can also be realized in various other configurations. For example, the invention can be realized as a display control method for a transmission-type display device, a computer program for realizing this display control method, and a recording medium with this computer program recorded therein, and the like.

### BRIEF DESCRIPTION OF THE DRAWINGS

The invention will be described with reference to the accompanying drawings, wherein like numbers reference like elements.

FIG. 1 is an explanatory view showing a schematic configuration of a head-mounted-display device as an embodiment of the invention.

FIG. 2 is a plan view of essential parts showing the configuration of an optical system provided in an image display unit.

FIG. 3 shows the configuration of essential parts of the image display unit, as viewed from the user.

FIG. 4 explains the angle of view of a camera.

FIG. 5 is a block diagram functionally showing the configuration of the HMD.

FIG. 6 is a block diagram functionally showing the configuration of a control device.

FIG. 7 is an explanatory view schematically showing the state of the interior of a vehicle which the user of the HMD drives.

FIG. 8 is an explanatory view schematically showing the state where the user of the HMD operates a navigation device, using an operation GUI.

FIG. 9 is a flowchart showing processing procedures of operation GUI display processing.

FIG. 10 is a flowchart showing processing procedures of operation GUI display processing.

FIG. 11 is an explanatory view showing an example of function information acquired from the navigation device.

FIG. 12 is an explanatory view schematically showing a schematic configuration of the operation GUI.

FIG. 13 is an explanatory view schematically showing the state where operation items of “overall function” are allocated to the operation GUI.

FIG. 14 shows a picked-up image in the state where the shape of the left hand of the user of the HMD is “rock”.

FIG. 15 is a picked-up image in the state where the shape of the left hand of the user of the HMD is “paper”.

FIG. 16 is an explanatory view schematically showing the operation GUI displayed on the image display unit.

FIG. 17 is an explanatory view schematically showing a gesture to designate the execution of the function of an operation item allocated to the operation GUI.

FIG. 18 is an explanatory view schematically showing the operation GUI after the execution of Step S170.

FIG. 19 is an explanatory view schematically showing the field of vision of the user after the execution of Step S170.

FIG. 20 is an explanatory view schematically showing a gesture to designate switching from a face of the operation GUI to another.

FIG. 21 is an explanatory view schematically showing the operation GUI after the execution of Step S180.

FIG. 22 is an explanatory view schematically showing a gesture to designate changing of the display position of the operation GUI.

FIG. 23 is an explanatory view schematically showing the field of vision of the user after the execution of Step S190.

FIG. 24 is an explanatory view schematically showing the operation GUI in Modification 2.

FIG. 25 is an explanatory view schematically showing a gesture to switch the operation GUI in Modification 2.

FIG. 26 is an explanatory view schematically showing the operation GUI after switching.

FIG. 27 is an explanatory view schematically showing the operation GUI in Modification 4.

### DESCRIPTION OF EXEMPLARY EMBODIMENTS

### A. Embodiment

### A1. Overall Configuration of Transmission-Type Display Device

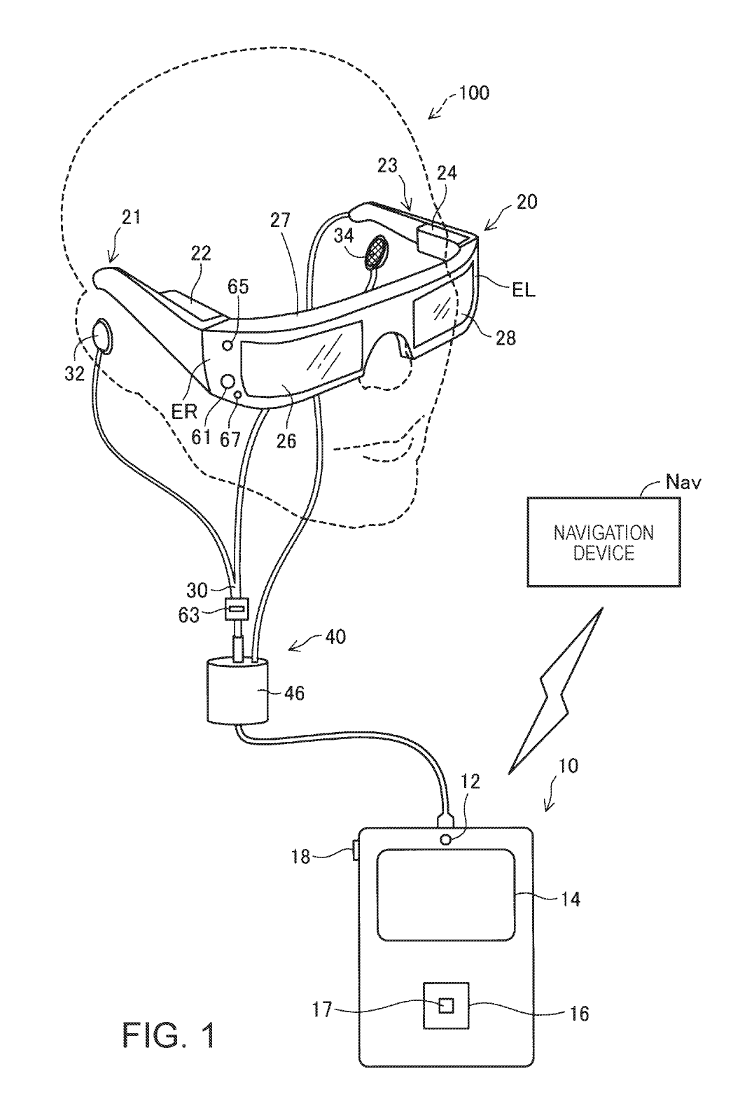

FIG. 1 is an explanatory view showing a schematic configuration of a head-mounted display device 100 as an embodiment of the invention. The head-mounted display device 100 is a display device mounted on the head of the user and is also called HMD. The HMD 100 is a see-through (transmission-type) head-mounted display device in which an image appears in an external field visually recognized through glasses.

In the embodiment, the user of the HMD 100 can drive a vehicle, wearing the HMD 100 on the head. FIG. 1 also shows a navigation device Nav installed on the vehicle which the user drives. The HMD 100 and the navigation device Nav are wirelessly connected to each other via a wireless communication unit 117, described later. In the embodiment, the user of the HMD 100 operates an operation GUI 500, described later, which is displayed on the HMD 100, and thus can operate the navigation device Nav and execute functions provided in the navigation device Nay. In the embodiment, the navigation device Nav is equivalent to the operation target device described in the summary section.

The HMD 100 includes an image display unit 20 which allows the user to visually recognize an image, and a control device (controller) 10 which controls the image display unit 20.

The image display unit 20 is a wearable unit to be mounted on the head of the user, and in this embodiment, is in the form of eyeglasses. The image display unit 20 has a right display unit 22, a left display unit 24, a right light guide plate 26, and a left light guide plate 28, in a support having a right holding part 21, a left holding part 23, and a front frame 27.

The right holding part 21 and the left holding part 23 each extend backward from both ends of the front frame 27 and hold the image display unit 20 on the head of the user, like the temples of eyeglasses. Of the two ends of the front frame 27, the end part situated on the right-hand side of the user when the user is wearing the image display unit 20 is referred to as an end part ER, and the end part situated on the left-hand side of the user is referred to as an end part EL. The right holding part 21 is provided, extending from the end part ER of the front frame 27 to a position corresponding to the right temporal region of the user when the user is wearing the image display unit 20. The left holding part 23 is provided, extending from the end part EL of the front frame 27 to the left temporal region of the user when the user is wearing the image display unit 20.

The right light guide plate 26 and the left light guide plate 28 are provided on the front frame 27. The right light guide plate 26 is situated in front of the right eye of the user when the user is wearing the image display unit 20, and allows the right eye to visually recognize an image. The left light guide plate 28 is situated in front of the left eye of the user when the user is wearing the image display unit 20, and allows the left eye to visually recognize an image.

The front frame 27 has a shape such that one end of the right light guide plate 26 and one end of the left light guide plate 28 are connected to each other. This connecting position corresponds to the position of the glabella of the user when the user is wearing the image display unit 20. On the front frame 27, a nose pad part to be butted against the nose of the user when the user is wearing the image display unit 20 may be provided at the connecting position between the right light guide plate 26 and the left light guide plate 28. In this case, the image display unit 20 can be held on the head of the user with the nose pad part, the right holding part 21, and the left holding part 23. Also, a belt that comes in contact with the back of the user's head when the user is wearing the image display unit 20 may be connected to the right holding part 21 and the left holding part 23. In this case, the image display unit 20 can be firmly held on the head of the user with the belt.

The right display unit 22 displays an image through the right light guide plate 26. The right display unit 22 is provided on the right holding part 21 and is situated near the right temporal region of the user when the user is wearing the image display unit 20. The left display unit 24 displays an image through the left light guide plate 28. The left display unit 24 is provided on the left holding part 23 and is situated near the left temporal region of the user when the user is wearing the image display unit 20.

The right light guide plate 26 and the left light guide plate 28 in this embodiment are optical units formed of a light-transmissive resin or the like (for example, prisms). The right light guide plate 26 and the left light guide plate 28 guide image light outputted from the right display unit 22 and the left display unit 24, to the eyes of the user. Also, a light adjusting plate may be provided on the surfaces of the right light guide plate 26 and the left light guide plate 28. The light adjusting plate is a thin plate-like optical element with its transmittance varying depending on the wavelength range of light, and functions as a so-called wavelength filter. The light adjusting plate is arranged, for example, in such a way as to cover the surface of the front frame 27 (surface opposite to the side facing the eyes of the user). By properly selecting optical characteristics of the light adjusting plate, it is possible to adjust the transmittance of light in an arbitrary wavelength range such as visibly ray, infrared ray, or ultraviolet ray, and to adjust the amount of external light that becomes incident on the right light guide plate 26 and the left light guide plate 28 from outside and is transmitted through the right light guide plate 26 and the left light guide plate 28.

The image display unit 20 guides the image light generated by each of the right display unit 22 and the left display unit 24 to the right light guide plate 26 and the left light guide plate 28 and allows the user to visually recognize an image based on this image light (augmented reality (AR) image) (this is also referred to as “displaying an image”) along with an external scene that is transmitted through the image display unit and visually recognized by the user. When external light is transmitted through the right light guide plate 26 and the left light guide plate 28 from in front of the user and becomes incident on the eyes of the user, the image light forming the image and the external light become incident on the eyes of the user. Therefore, the visibility of the image to the user is influenced by the intensity of the external light.

Thus, for example, by installing a light adjusting plate on the front frame 27 and properly selecting or adjusting optical characteristics of the light adjusting plate, it is possible to adjust the visibility of the image. As a typical example, a light adjusting plate having such a light transmittance that the user wearing the HMD 100 can visually recognize at least the external scene can be selected. Also, sunlight can be restrained and the visibility of the image can be increased. Moreover, using the light adjusting plate can be expected to have effects such as protecting the right light guide plate 26 and the left light guide plate 28 and restraining damage to or stains on the right light guide plate 26 and the left light guide plate 28. The light adjusting plate may be attachable to/removable from the front frame 27 or each of the right light guide plate 26 and the left light guide plate 28. It may also be possible to attach/remove a plurality of types of light adjusting plates, replacing one with another. Alternatively, the light adjusting plate may be omitted.

A camera 61 is arranged on the front frame 27 of the image display unit 20. The camera 61 is provided at a position that does not block the external light transmitted through the right light guide plate 26 and the left light guide plate 28, on the front surface of the front frame 27. In the example of FIG. 1, the camera 61 is arranged on the side of the end part ER of the front frame 27. The camera 61 may be arranged on the side of the end part EL of the front frame 27, or may be arranged at the connecting part between the right light guide plate 26 and the left light guide plate 28.

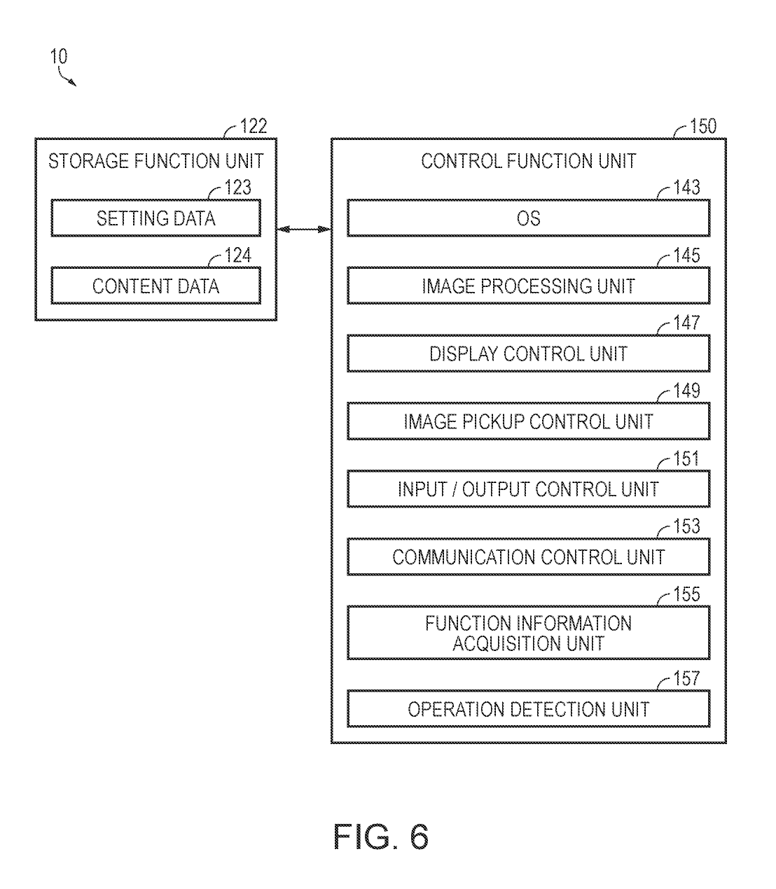

The camera 61 is a digital camera having an image pickup element such as CCD or CMOS, and an image pickup lens or the like. While the camera 61 in this embodiment is a monocular camera, a stereo camera may be employed. The camera 61 picks up an image of at least a part of the external field (real space) in the direction of the front of the HMD 100, that is, in the field of vision visually recognized by the user when the user is wearing the image display unit 20. In other words, the camera 61 picks up an image in a range or direction overlapping with the field of vision of the user, and picks up an image in the direction in which the user looks. The width of the angle of view of the camera 61 can be suitably set. In this embodiment, the width of the angle of view of the camera 61 is set in such a way as to pick up an image of the entirety of the field of vision of the user that the user can visually recognize through the right light guide plate 26 and the left light guide plate 28. The camera 61 executes image pickup under the control of a control function unit 150 (FIG. 6) and outputs the resulting picked-up image data to the control function unit 150.

The HMD 100 may have a distance sensor which detects the distance to a measurement target object located in a preset direction of measurement. The distance sensor can be arranged, for example, at the connecting part between the right light guide plate 26 and the left light guide plate 28 of the front frame 27. The direction of measurement by the distance sensor can be the direction of the front side of the HMD 100 (direction overlapping with the direction of image pickup by the camera 61). The distance sensor can be configured of, for example, a light emitting unit such as an LED or laser diode, and a light receiving unit which receives reflected light that is the light emitted from the light source and then reflected by the measurement target object. In this case, the distance is found by triangulation or by distance measuring processing based on time lag. The distance sensor may also be configured of, for example, a transmitting unit which emits ultrasonic waves, and a receiving unit which receives ultrasonic waves reflected by the measurement target object. In this case, the distance is found by distance measuring processing based on time lag. The distance sensor, similarly to the camera 61, measures the distance according to an instruction from the control function unit 150 and outputs the result of the detection to the control function unit 150.

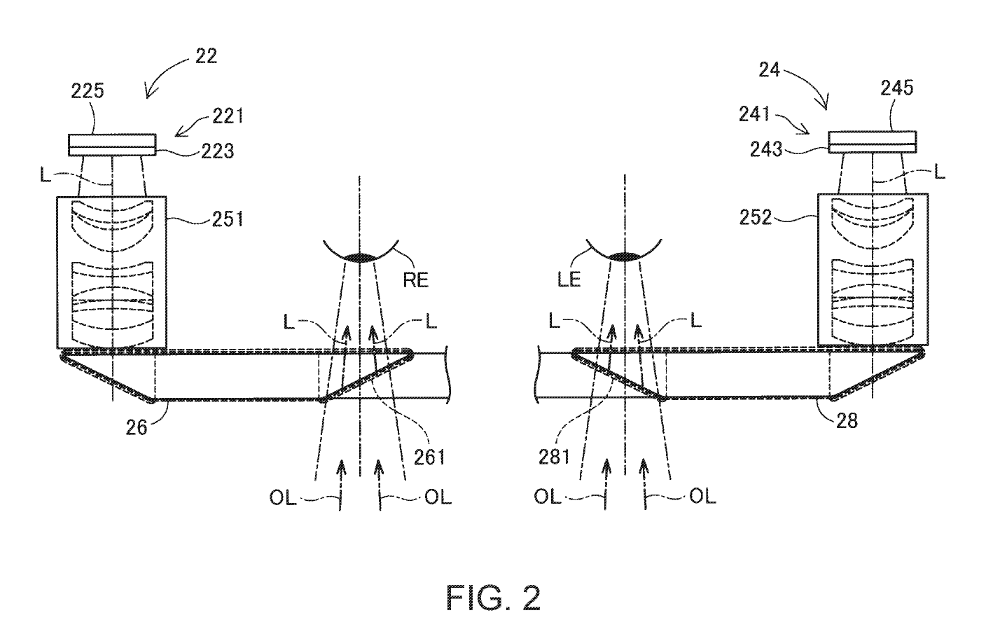

FIG. 2 is a plan view of essential parts showing the configuration of the optical system provided in the image display unit 20. For the sake of convenience of the description, FIG. 2 illustrates the right eye RE and the left eye LE of the user. As shown in FIG. 2, the right display unit 22 and the left display unit 24 are configured to be bilaterally symmetrical to each other.

As a configuration to allow the right eye RE to visually recognize an image (AR image), the right display unit 22 has an OLED (organic light emitting diode) unit 221 and a right optical system 251. The OLED unit 221 emits image light. The right optical system 251 has a lens group or the like and guides the image light L emitted from the OLED unit 221, to the right light guide plate 26.

The OLED unit 221 has an OLED panel 223 and an OLED drive circuit 225 which drives the OLED panel 223. The OLED panel 223 is a self-emitting display panel configured of light emitting elements which emit light by organic electroluminescence and emit color lights of R (red), G (green), and B (blue), respectively. In the OLED panel 223, a plurality of pixels, each pixel including one R, G and B element each, is arranged in the form of a matrix.

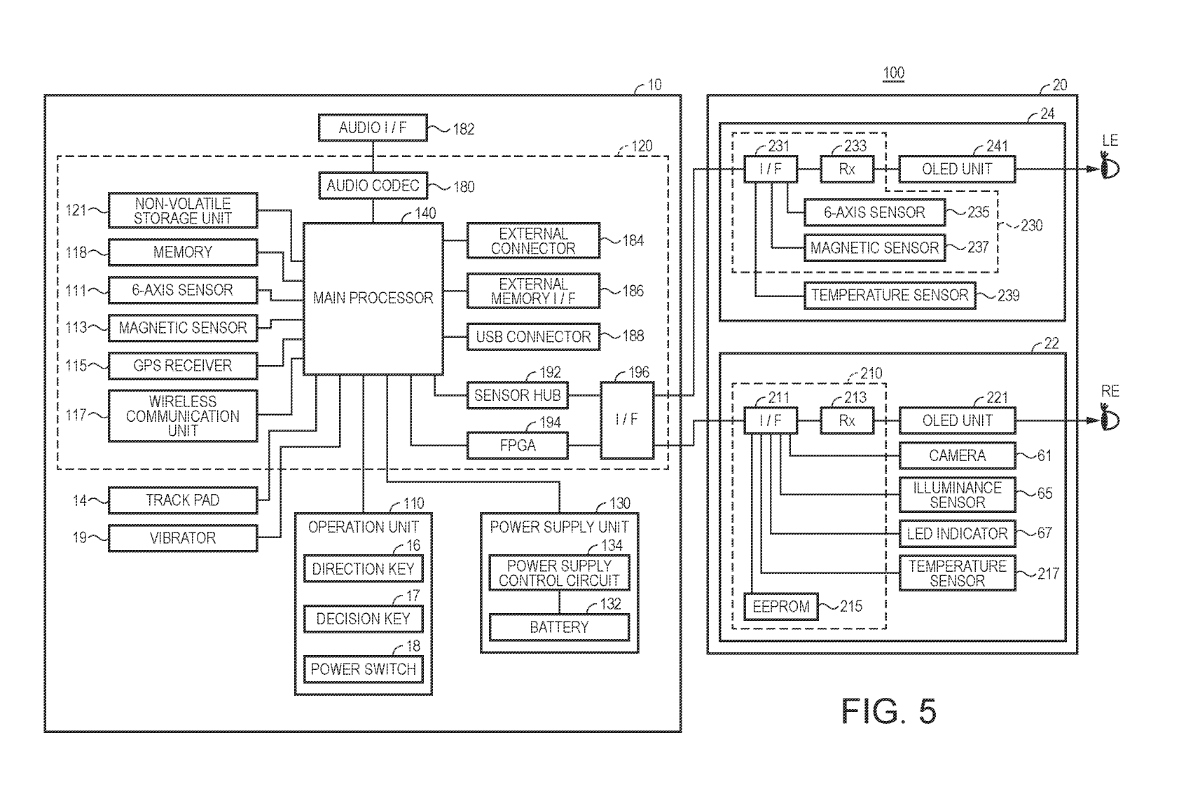

The OLED drive circuit 225 executes selection from and energization of the light emitting elements provided in the OLED panel 223 and causes the light emitting elements to emit light, under the control of the control function unit 150 (FIG. 6), described later. The OLED drive circuit 225 is fixed to the back side of the OLED panel 223, that is, the back side of the light emitting surface, by bonding or the like. The OLED drive circuit 225 may be configured of, for example, a semiconductor device which drives the OLED panel 223, and may be mounted on a substrate fixed to the back side of the OLED panel 223. On this substrate, a temperature sensor 217 (FIG. 5), described later, is mounted. The OLED panel 223 may employ a configuration in which light emitting elements that emit white light are arranged in the form of a matrix, with color filters corresponding to the respective colors of R, G and B superimposed thereon. Moreover, the OLED panel 223 with a WRGB configuration having a light emitting element which radiates W (white) light in addition to light emitting elements which radiate the color lights of R, G and B may be employed.

The right optical system 251 has a collimating lens which turns the image light L emitted from the OLED panel 223 into a parallel luminous flux. The image light L, turned into the parallel luminous flux by the collimating lens, becomes incident on the right light guide plate 26. In the optical path which guides the light inside the right light guide plate 26, a plurality of reflection surfaces that reflects the image light L is formed. The image light L is reflected a plurality of times inside the right light guide plate 26 and is thus guided toward the right eye RE. On the right light guide plate 26, a half mirror 261 (reflection surface) situated in front of the right eye RE is formed. The image light L is reflected by the half mirror 261 and subsequently emitted from the right light guide plate 26 to the right eye RE. This image light L forms an image on the retina of the right eye RE, thus allowing the user to visually recognize the image.

As a configuration to allow the left eye LE to visually recognize an image (AR image), the left display unit 24 has an OLED unit 241 and a left optical system 252. The OLED unit 241 emits image light. The left optical system 252 has a lens group or the like and guides the image light L emitted from the OLED unit 241, to the left light guide plate 28. The OLED unit 241 has an OLED panel 243 and an OLED drive circuit 245 which drives the OLED panel 243. The details of these respective parts are the same as those of the OLED unit 221, the OLED panel 223, and the OLED drive circuit 225. A temperature sensor 239 (FIG. 5) is mounted on a substrate fixed to the back side of the OLED panel 243. The details of the left optical system 252 are the same as those of the right optical system 251.

With the configuration described above, the HMD 100 can function as a see-through display device. That is, the image light L reflected by the half mirror 261 and external light OL transmitted through the right light guide plate 26 become incident on the right eye RE of the user. The image light L reflected by a half mirror 281 and external light OL transmitted through the left light guide plate 28 become incident on the left eye LE of the user. In this way, the HMD 100 causes the image light L of the image processed inside and the external light OL to become incident, as superimposed on each other, on the eyes of the user. As a result, the user sees the external scene (real world) through the right light guide plate 26 and the left light guide plate 28 and visually recognizes a virtual image (AR image) based on the image light L as superimposed on the external scene.

The right optical system 251 and the right light guide plate 26 are collectively referred to as a “right light guide unit”. The left optical system 252 and the left light guide plate 28 are collectively referred to as a “left light guide unit”. The configurations of the right light guide unit and the left light guide unit are not limited to the foregoing example. An arbitrary form can be used, provided that an image is formed in front of the eyes of the user, using image light. For example, a diffraction grating may be used, or a semi-transmissive reflection film may be used for the right light guide unit and the left light guide unit.

In FIG. 1, the control device 10 and the image display unit 20 are connected together via a connection cable 40. The connection cable 40 is removably connected to a connector provided in a bottom part of the control device 10 and connects to various circuits inside the image display unit 20 from the distal end of the left holding part 23. The connection cable 40 has a metal cable or optical fiber cable which transmits digital data. The connection cable 40 may also include a metal cable which transmits analog data. A connector 46 is provided at a halfway point along the connection cable 40.

The connector 46 is a socket to connect a stereo mini plug. The connector 46 and the control device 10 are connected together, for example, via a line which transmits analog audio signals. In the example of this embodiment shown in FIG. 1, a right earphone 32 and a left earphone 34 forming stereo headphones, and a headset 30 having a microphone 63, are connected to the connector 46.

The microphone 63 is arranged in such a way that the sound collecting part of the microphone 63 faces the direction of the line of sight of the user, for example, as shown in FIG. 1. The microphone 63 collects sounds and outputs audio signals to an audio interface 182 (FIG. 5). The microphone 63 may be a monaural microphone or stereo microphone, and may be a directional microphone or non-directional microphone.

The control device 10 is a device for controlling the HMD 100. The control device 10 includes a lighting part 12, a track pad 14, a direction key 16, a decision key 17, and a power switch 18. The lighting part 12 notifies the operating state (for example, power ON/OFF or the like) of the HMD 100, by its light emitting mode. As the lighting part 12, for example, an LED (light emitting diode) can be used.

The track pad 14 detects a touch operation on the operation surface of the track pad 14 and outputs a signal corresponding to the detected content. As the track pad 14, various track pads such as electrostatic, pressure detection-type, and optical track pads can be employed. The direction key 16 detects a press operation on keys corresponding to up, down, left and right directions and outputs a signal corresponding to the detected content. The decision key 17 detects a press operation and outputs a signal for deciding the content of the operation carried out on the control device 10. The power switch 18 switches the state of the power supply of the HMD 100 by detecting a slide operation of the switch.

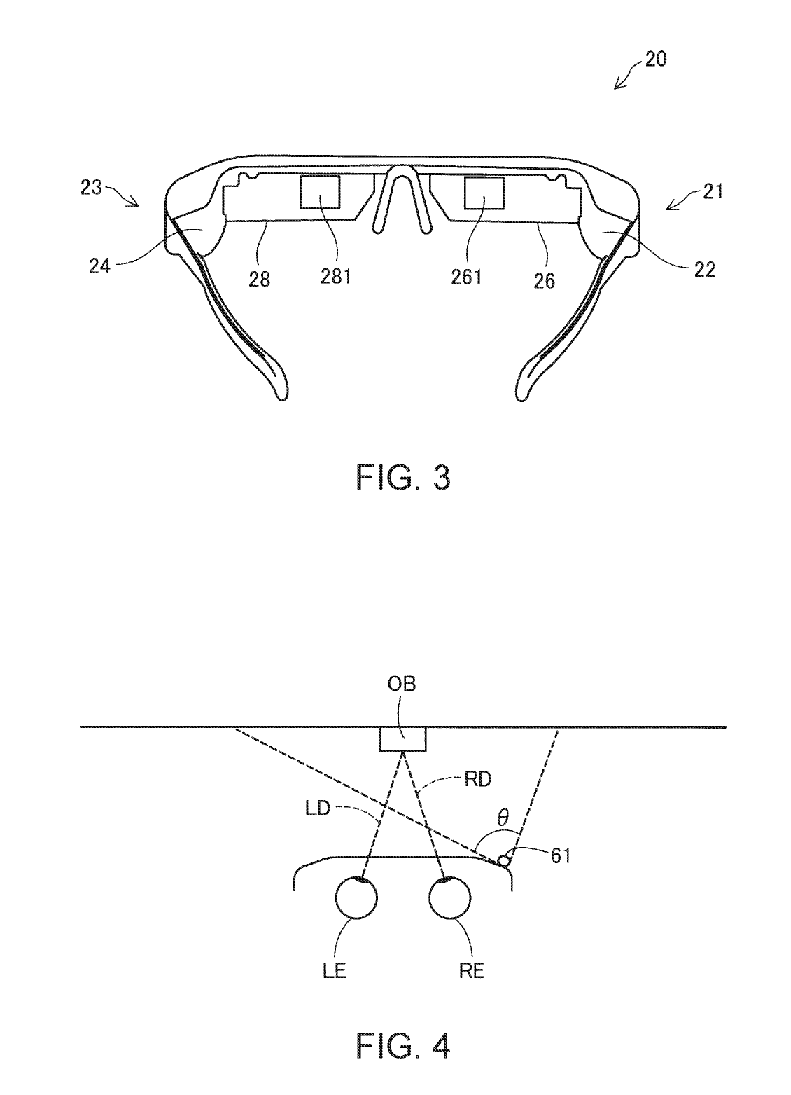

FIG. 3 shows the configuration of essential parts of the image display unit 20, as viewed from the user. In FIG. 3, the illustration of the connection cable 40, the right earphone 32, and the left earphone 34 is omitted. In the state shown in FIG. 3, the back sides of the right light guide plate 26 and the left light guide plate 28 can be visually recognized, and the half mirror 261 for casting image light to the right eye RE and the half mirror 281 for casting image light to the left eye LE can be visually recognized as substantially quadrilateral areas. The user visually recognizes the external scene through the entirety of the left and right light guide plates 26, 28 including the half mirrors 261, 281, and also visually recognizes a rectangular display image at the positions of the half mirrors 261, 281.

FIG. 4 explains the angle of view of the camera 61. In FIG. 4, the camera 61, and the right eye RE and the left eye LE of the user are schematically shown in a plan view, and the angle of view (image pickup range) of the camera 61 is indicated by θ. The angle of view θ of the camera 61 spreads in the horizontal direction as illustrated and also spreads in the vertical direction as with a general digital camera.

As described above, the camera 61 is arranged at the end part on the right-hand side of the image display unit 20, and picks up an image in the direction of the line of sight of the user (that is, in front of the user). Therefore, the optical axis of the camera 61 is in a direction including the directions of the lines of sight of the right eye RE and the left eye LE. The external scene which the user can visually recognize when wearing the HMD 100 is not necessarily at infinity. For example, when the user gazes at an object OB with both eyes, the lines of sight of the user are directed to the object OB, as indicated by the signs RD and LD in the illustration. In this case, the distance from the user to the object OB tends to be approximately 30 cm to 10 m, and more frequently, 1 m to 4 m. Thus, upper and lower limit benchmarks of the distance from the user to the object OB at the time of normal use may be defined for the HMD 100. The benchmarks may be found in advance and preset in the HMD 100, or may be set by the user. It is preferable that the optical axis and the angle of view of the camera 61 are set in such a way that the object OB is included in the angle of view when the distance to the object OB at the time of normal use corresponds to the set upper and lower limit benchmarks.

Generally, the human viewing angle is considered to be approximately 200 degrees horizontally and approximately 125 degrees vertically. Of this range, the useful field of view, where an excellent information extraction ability can be exerted, is approximately 30 degrees horizontally and approximately 20 degrees vertically. The stable fixation field, where a gazing point at which a human gazes can be viewed quickly and stably, is considered to be approximately 60 to 90 degrees horizontally and approximately 45 to 70 degrees vertically. In this case, when the gazing point is the object OB (FIG. 4), the useful field of view is approximately 30 degrees horizontally and approximately 20 degrees vertically, with the lines of sight RD, LD at its center. The stable fixation field is approximately 60 to 90 degrees horizontally and approximately 45 to 70 degrees vertically. The actual field of view which the user visually recognizes through the image display unit 20 and through the right light guide plate 26 and the left light guide plate 28 is referred to as FOV (field of view). The field of view is narrower than the viewing angle and the stable fixation field but broader than the useful field of view.

The angle of view θ of the camera 61 in this embodiment is set in such a way as to be able to pick up an image over a broader range than the field of view of the user. Preferably, the angle of view θ of the camera 61 may be set in such a way as to be able to pick up an image over at least a broader range than the useful field of view of the user. More preferably, the angle of view θ of the camera 61 may be set in such a way as to be able to pick up an image over a broader range than the field of view. More preferably, the angle of view θ of the camera 61 may be set in such a way as to be able to pick up an image over a broader range than the stable fixation field of the user. Most preferably, the angle of view θ of the camera 61 may be set in such a way as to be able to pick up an image over a broader range than the viewing angles of both eyes of the user. Therefore, the camera 61 may have a so-called wide-angle lens as an image pickup lens and thus may be configured to be able to pick up an image over a broad angle of view. The wide-angle lens may include a lens called an ultra-wide-angle lens or quasi-wide-angle lens. The camera 61 may also include a monofocal lens or a zoom lens, and may include a lens group made up of a plurality of lenses.

FIG. 5 is a block diagram functionally showing the configuration of the HMD 100. The control device 10 includes a main processor 140 which executes a program and controls the HMD 100, a storage unit, an input/output unit, sensors, an interface, and a power supply unit 130. The storage unit, the input/output unit, the sensors, the interface, and the power supply unit 130 are connected to the main processor 140. The main processor 140 is mounted on a controller board 120 built in the control device 10.

The storage unit includes a memory 118 and a non-volatile storage unit 121. The memory 118 forms a work area for temporarily storing a computer program executed by the main processor 140 and processed data. The non-volatile storage unit 121 is configured of a flash memory or eMMC (embedded multimedia card). The non-volatile storage unit 121 stores a computer program executed by the main processor 140 and various data processed by the main processor 140. In this embodiment, these storage units are mounted on the controller board 120.

The input/output unit includes the track pad 14 and an operation unit 110. The operation unit 110 includes the direction key 16, the decision key 17, and the power switch 18 provided in the control device 10. The main processor 140 controls each of these input/output units and acquires a signal outputted from each of the input/output units.

The sensors include a 6-axis sensor 111, a magnetic sensor 113, and a GPS (global positioning system) receiver 115. The 6-axis sensor 111 is a motion sensor (inertial sensor) having a 3-axis acceleration sensor and a 3-axis gyro (angular velocity) sensor. As the 6-axis sensor 111, an IMU (inertial measurement unit) in which these sensors are formed as modules may be employed. The magnetic sensor 113 is, for example, a 3-axis geomagnetic sensor. The GPS receiver 115 has a GPS antenna, not illustrated, and thus receives radio signals transmitted from GPS satellites and detects the coordinates of the current location of the control device 10. These sensors (6-axis sensor 111, magnetic sensor 113, GPS receiver 115) output detected values to the main processor 140 according to a sampling frequency designated in advance. The timing when each sensor outputs a detected value may be in response to an instruction from the main processor 140.

The interface includes a wireless communication unit 117, an audio codec 180, an external connector 184, an external memory interface 186, a USB (universal serial bus) connector 188, a sensor hub 192, an FPGA 194, and an interface 196. These components function as interfaces to the outside.

The wireless communication unit 117 executes wireless communication between the HMD 100 and an external device. The wireless communication unit 117 includes an antenna, an RF circuit, a baseband circuit, a communication control circuit and the like, not illustrated. Alternatively, the wireless communication unit 117 is configured as a device in which these components are integrated. The wireless communication unit 117 carries out wireless communication conforming to a wireless LAN standard including, for example, Bluetooth (trademark registered) or Wi-Fi (trademark registered). In this embodiment, the wireless communication unit 117 carries out wireless communication conforming to Wi-Fi (trademark registered) between the navigation device Nav and the HMD 100.

The audio codec 180 is connected to an audio interface 182 and encodes and decodes an audio signal inputted and outputted via the audio interface 182. The audio interface 182 is an interface for inputting and outputting an audio signal. The audio codec 180 may have an A/D converter which converts an analog audio signal into digital audio data, or a D/A converter which carries out reverse conversion. The HMD 100 in this embodiment outputs a sound from the right earphone 32 and the left earphone 34 and collects a sound with the microphone 63. The audio codec 180 converts digital audio data outputted from the main processor 140 into an analog audio signal and outputs the analog audio signal via the audio interface 182. Also, the audio codec 180 converts an analog audio signal inputted to the audio interface 182 into digital audio data and outputs the digital audio data to the main processor 140.

The external connector 184 is a connector for connecting an external device which communicates with the main processor 140 (for example, a personal computer, smartphone, game machine or the like), to the main processor 140. The external device connected to the external connector 184 can be a source of content and can also be used to debug a computer program executed by the main processor 140 or to collect operation logs of the HMD 100. The external connector 184 can employ various forms. As the external connector 184, for example, an interface which supports wired connection such as a USB interface, micro USB interface or memory card interface, or an interface which supports wireless connection such as a wireless LAN interface or Bluetooth interface can be employed.

The external memory interface 186 is an interface to which a portable memory device can be connected. The external memory interface 186 includes, for example, a memory card slot in which a card-type recording medium is loaded to read or write data, and an interface circuit. The size, shape, standard and the like of the card-type recording medium can be suitably selected. The USB connector 188 is an interface to which a memory device, smartphone, personal computer or the like conforming to the USB standard can be connected. The USB connector 188 includes, for example, a connector conforming to the USB standard, and an interface circuit. The size, shape, USB standard version and the like of the USB connector 188 can be suitably selected.

The HMD 100 also has a vibrator 19. The vibrator 19 has a motor and an eccentric rotor or the like, not illustrated, and generates vibration under the control of the main processor 140. For example, when an operation on the operation unit 110 is detected or when the power of the HMD 100 is switched on/off, or the like, the HMD 100 causes the vibrator 19 to generate vibration in a predetermined vibration pattern. The vibrator 19 may be provided on the side of the image display unit 20, for example, in the right holding part 21 (right-hand side part of the temples) of the image display unit, instead of being provided in the control device 10.

The sensor hub 192 and the FPGA 194 are connected to the image display unit 20 via the interface (I/F) 196. The sensor hub 192 acquires detected values from various sensors provided in the image display unit 20 and outputs the detected values to the main processor 140. The FPGA 194 executes processing of data sent and received between the main processor 140 and each part of the image display unit 20 and transmission of the data via the interface 196. The interface 196 is connected to each of the right display unit 22 and the left display unit 24 of the image display unit 20. In the example of this embodiment, the connection cable 40 is connected to the left holding part 23, and a wire leading to this connection cable 40 is laid inside the image display unit 20. Each of the right display unit 22 and the left display unit 24 is thus connected to the interface 196 of the control device 10.

The power supply unit 130 includes a battery 132 and a power supply control circuit 134. The power supply unit 130 supplies electric power for the control device 10 to operate. The battery 132 is a rechargeable battery. The power supply control circuit 134 detects the remaining capacity of the battery 132 and controls an OS 143 (FIG. 6) for recharging. The power supply control circuit 134 is connected to the main processor 140 and outputs the detected value of the remaining capacity of the battery 132 and the detected value of the voltage of the battery 132 to the main processor 140. Based on the electric power supplied by the power supply unit 130, electric power may be supplied from the control device 10 to the image display unit 20. The main processor 140 may be configured to be able to control the state of supply of electric power from the power supply unit 130 to each part of the control device 10 and the image display unit 20.

The right display unit 22 has a display unit board 210, the OLED unit 221, the camera 61, an illuminance sensor 65, an LED indicator 67, and a temperature sensor 217. On the display unit board 210, an interface (I/F) 211 connected to the interface 196, a receiving unit (Rx) 213, and an EEPROM (electrically erasable programmable read-only memory) 215 are mounted. The receiving unit 213 receives data inputted from the control device 10 via the interface 211. When image data of an image to be displayed by the OLED unit 221 is received, the receiving unit 213 outputs the received image data to the OLED drive circuit 225 (FIG. 2).

The EEPROM 215 stores various data in a form readable by the main processor 140. The EEPROM 215 stores, for example, data about light emission characteristics and display characteristics of the OLED units 221, 241 of the image display unit 20, and data about sensor characteristics of the right display unit 22 and the left display unit 24, or the like. Specifically, the EEPROM 215 stores, for example, a parameter for gamma correction of the OLED units 221, 241, and data for compensating for detected values from the temperature sensors 217, 239, or the like. These data are generated by an inspection and written in the EEPROM 215 at the time of shipping the HMD 100 from the plant. After the shipping, the main processor 140 reads the data in the EEPROM 215 and uses the data for various kinds of processing.

The camera 61 executes image pickup according to a signal inputted via the interface 211 and outputs picked-up image data or a signal indicating the result of the image pickup to the control device 10. The illuminance sensor 65 is provided at the end part ER of the front frame 27 and arranged in such a way as to receive external light from in front of the user wearing the image display unit 20, as shown in FIG. 1. The illuminance sensor 65 outputs a detected value corresponding to the amount of light received (intensity of received light). The LED indicator 67 is arranged near the camera 61 at the end part ER of the front frame 27, as shown in FIG. 1. The LED indicator 67 turns on during the execution of image pickup by the camera 61 and thus reports that image pickup is in progress.

The temperature sensor 217 detects temperature and outputs a voltage value or resistance value corresponding to the detected temperature. The temperature sensor 217 is mounted on the back side of the OLED panel 223 (FIG. 2). The temperature sensor 217 may be mounted, for example, on the same substrate as the OLED drive circuit 225. With this configuration, the temperature sensor 217 mainly detects the temperature of the OLED panel 223. Also, the temperature sensor 217 may be built in the OLED panel 223 or the OLED drive circuit 225 (FIG. 2). For example, if the OLED panel 223 as a Si-OLED is mounted along with the OLED drive circuit 225 as an integrated circuit on an integrated semiconductor chip, the temperature sensor 217 may be mounted on this semiconductor chip.

The left display unit 24 has a display unit board 230, the OLED unit 241, and a temperature sensor 239. On the display unit board 230, an interface (I/F) 231 connected to the interface 196, a receiving unit (Rx) 233, a 6-axis sensor 235, and a magnetic sensor 237 are mounted. The receiving unit 233 receives data inputted from the control device 10 via the interface 231. When image data of an image to be displayed by the OLED unit 241 is received, the receiving unit 233 outputs the received image data to the OLED drive circuit 245 (FIG. 2).

The 6-axis sensor 235 is a motion sensor (inertial sensor) having a 3-axis acceleration sensor and a 3-axis gyro (angular velocity) sensor. As the 6-axis sensor 235, an IMU sensor in which the above sensors are formed as modules may be employed. The magnetic sensor 237 is, for example, a 3-axis geomagnetic sensor. The 6-axis sensor 235 and the magnetic sensor 237 are provided in the image display unit 20 and therefore detect a movement of the head of the user when the image display unit 20 is mounted on the head of the user. Based on the detected movement of the head, the direction of the image display unit 20, that is, the field of vision of the user, is specified.

The temperature sensor 239 detects temperature and outputs a voltage value or resistance value corresponding to the detected temperature. The temperature sensor 239 is mounted on the back side of the OLED panel 243 (FIG. 2). The temperature sensor 239 may be mounted, for example, on the same substrate as the OLED drive circuit 245. With this configuration, the temperature sensor 239 mainly detects the temperature of the OLED panel 243. The temperature sensor 239 may be built in the OLED panel 243 or the OLED drive circuit 245 (FIG. 2). The details of the temperature sensor 239 are similar to those of the temperature sensor 217.

The camera 61, the illuminance sensor 65 and the temperature sensor 217 of the right display unit 22, and the 6-axis sensor 235, the magnetic sensor 237 and the temperature sensor 239 of the left display unit 24 are connected to the sensor hub 192 of the control device 10. The sensor hub 192 carries out setting of a sampling frequency and initialization of each sensor under the control of the main processor 140. The sensor hub 192 executes energization of each sensor, transmission of control data, acquisition of a detected value or the like, according to the sampling period of each sensor. The sensor hub 192 outputs the detected value from each sensor provided in the right display unit 22 and the left display unit 24 to the main processor 140 at a preset timing. The sensor hub 192 may have a cache function to temporarily hold the detected value from each sensor. The sensor hub 192 may have the function of converting the signal format or data format of the detected value from each sensor (for example, to convert to a unified format). The FPGA 194 starts or stops the energization of the LED indicator 67 under the control of the main processor 140 and thus causes the LED indicator 67 to turn on or off.

FIG. 6 is a block diagram functionally showing the configuration of the control device 10. Functionally, the control device 10 has a storage function unit 122 and a control function unit 150. The storage function unit 122 is a logical storage unit configured of the non-volatile storage unit 121 (FIG. 5). The storage function unit 122 may have a configuration using the EEPROM 215 and the memory 118 in combination with the non-volatile storage unit 121, instead of the configuration using only the non-voltage storage unit 121. The control function unit 150 is configured by the main processor 140 executing a computer program, that is, by hardware and software collaborating with each other.

In the storage function unit 122, various data used for processing in the control function unit 150 are stored. Specifically, in the storage function unit 122 in this embodiment, setting data 123 and content data 124 are stored. The setting data 123 includes various setting values related to the operation of the HMD 100. For example, the setting data 123 includes a parameter, determinant, arithmetic expression, LUT (lookup table) or the like used when the control function unit 150 controls the HMD 100.

The content data 124 includes data of content (image data, video data, audio data or the like) including an image or video to be displayed by the image display unit 20 under the control of the control function unit 150. The content data 124 may include data of bidirectional content. The bidirectional content refers to content displayed by the image display unit 20, corresponding to the content of processing executed by the control function unit 150, corresponding to the content of an operation by the user acquired via the operation unit 110. In this case, the data of the content can include image data of a menu screen for acquiring the operation by the user, and data for deciding processing corresponding to an item included in the menu screen, and the like.

The control function unit 150 executes various kinds of processing using the data stored in the storage function unit 122, and thus executes the functions of an OS (operating system) 143, an image processing unit 145, a display control unit 147, an image pickup control unit 149, an input/output control unit 151, a communication control unit 153, a function information acquisition unit 155, and an operation detection unit 157. In this embodiment, each of the functional units other than the OS 143 is configured as a computer program executed on the OS 143.

The image processing unit 145 generates a signal to be transmitted to the right display unit 22 and the left display unit 24, based on image data of an image or video to be displayed by the image display unit 20. The signal generated by the image processing unit 145 may be a vertical synchronization signal, horizontal synchronization signal, clock signal, analog image signal or the like. The image processing unit 145 may be realized by the main processor 140 executing a computer program, or may be configured of hardware (for example, DSP (digital signal processor)) that is different from the main processor 140.

The image processing unit 145 may execute resolution conversion processing, image adjustment processing, 2D/3D conversion processing or the like, according to need. The resolution conversion processing is processing to convert the resolution of image data to a resolution suitable for the right display unit 22 and the left display unit 24. The image adjustment processing is processing to adjust the luminance and saturation of image data. The 2D/3D conversion processing is processing to generate two-dimensional image data from three-dimensional image data, or to generate three-dimensional image data from two-dimensional image data. In the case where such processing is executed, the image processing unit 145 generates a signal for displaying an image based on the image data resulting from the processing, and transmits the signal to the image display unit 20 via the connection cable 40.

The display control unit 147 generates a control signal to control the right display unit 22 and the left display unit 24, and with this control signal, controls the generation and emission of image light by each of the right display unit 22 and the left display unit 24. Specifically, the display control unit 147 controls the OLED drive circuits 225, 245 so as to cause the OLED panels 223, 243 to display an image. Based on a signal outputted from the image processing unit 145, the display control unit 147 performs control on the timing when the OLED drive circuits 225, 245 cause the OLED panels 223, 243 to display an image, and control on the luminance of the OLED panels 223, 243, or the like.

The display control unit 147 also controls the display on an operation GUI 500, described later, in operation GUI display processing, described later. In the operation GUI display processing, the operation GUI 500 is displayed at a position corresponding to a gesture of the user. Also, the execution of an operation associated in advance to the operation GUI 500 is controlled according to an operation instruction based on a gesture of the user. Details of the operation GUI display processing will be described later.

The image pickup control unit 149 controls the camera 61 to execute image pickup, generate picked-up image data, and temporarily store the picked-up image data in the storage function unit 122. If the camera 61 is configured as a camera unit including a circuit which generates picked-up image data, the image pickup control unit 149 acquires picked-up image data from the camera 61 and temporarily stores the picked-up image data in the storage function unit 122. Also, in the operation GUI display processing, described later, the image pickup control unit 149 picks up an image of the field of vision of the user and acquires a picked-up image according to an instruction from the display control unit 147.

The input/output control unit 151 controls the track pad 14 (FIG. 1), the direction key 16, and the decision key 17, where appropriate, and acquires an input command from these. The acquired command is outputted to the OS 143 or a computer program operating on the OS 143 along with the OS 143.

The communication control unit 153 controls the wireless communication unit 117 to carry out wireless communication with the navigation device Nay. The function information acquisition unit 155 acquires function information (function information FL, described later) of the navigation device Nav in the operation GUI display processing, described later. The operation detection unit 157 analyzes a picked-up image of the field of view of the user and thus detects a gesture of the user, in the operation GUI display processing, described later.

### A2. Operation GUI Display Processing

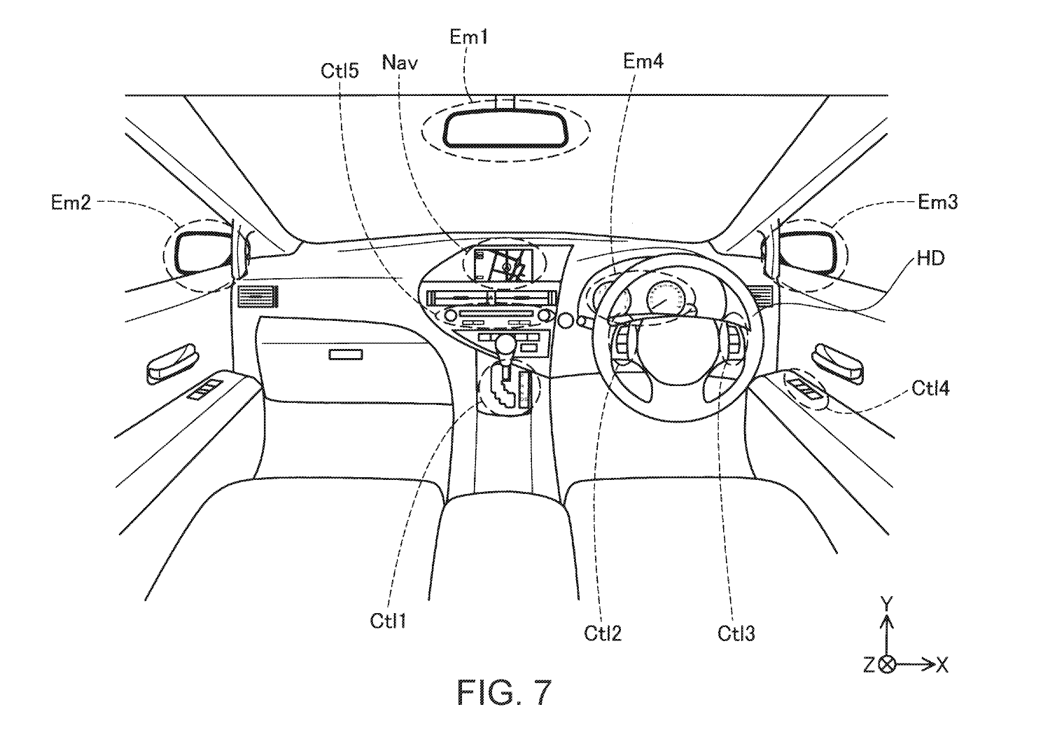

FIG. 7 is an explanatory view schematically showing the interior of a vehicle which the user of the HMD 100 drives. In FIG. 7, a Y-axis direction is set to be parallel to the vertical direction, and an X-axis direction and a Z-axis direction are set to be parallel to the horizontal direction. The Z-axis is parallel to the traveling direction of the vehicle. A +Z direction is equivalent to a direction parallel to the forward direction of the vehicle. A −Z direction is equivalent to a direction parallel to the backward direction of the vehicle. The X-axis is parallel to the direction of width of the vehicle. A +X direction is equivalent to the right-hand side of the user of the HMD 100. A −X direction is equivalent to the left-hand side of the user of the HMD 100. The same applies to the subsequent drawings.

Generally, when driving a vehicle, a driver puts the hand on the steering wheel HD and looks ahead of the vehicle. During this time, the driver shifts his/her line of sight to various devices in the interior room of the vehicle. For example, the driver may shift the line of sight to a speedometer Em4 in order to check the speed of the vehicle. Also, for example, the driver may shift the line of sight to side mirrors Em2 and Em3 and a rear-view mirror Em1 in order to check left, right and rear areas of the vehicle. Moreover, the driver may shift the light of sight to various devices Ctl1 to Ctl5 and operates these devices in order to cope with various driving circumstances. Therefore, if the driver focuses the light of sight on the navigation device Nav when operating the navigation device Nav, there is a risk of lowered safety of driving the vehicle. Therefore, in the embodiment, a graphical user interface (operation graphical user interface (hereinafter referred to as “operation GUI”), described later) for operating the navigation device Nav is displayed on the HMD 100. Thus, the movement of the light of sight by the driver when operating the navigation device Nav is reduced and the reduction in the safety of driving the vehicle is restrained.

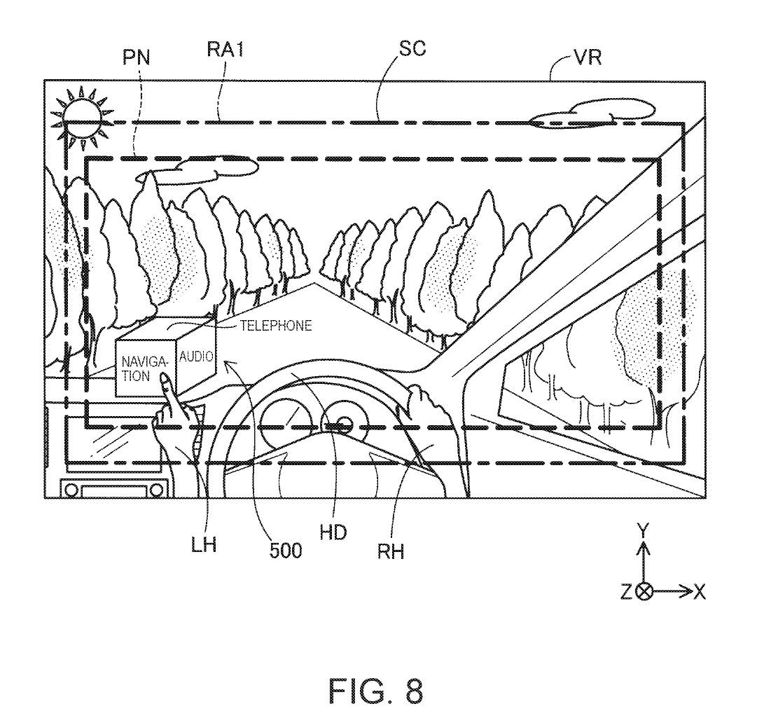

FIG. 8 is an explanatory view schematically showing the state where the user of the HMD 100 operates the navigation device Nav, using the operation GUI 500. In FIG. 8, a field of vision VR of the user is shown. As shown in FIG. 8, the operation GUI 500, described later, in a display area PN is displayed. In the display area PN, the user visually recognizes the operation GUI 500, described later, as superimposed on an external field SC. Meanwhile, outside the display area PN, the user visually recognizes only the external field SC.

In the embodiment, the “operation GUI” refers to a graphical user interface used by the user of the HMD 100 when operating various functions related to the navigation device Nay. As shown in FIG. 8, the operation GUI 500 is in the shape of a polyhedron and a name indicating each function of the navigation device Nav is displayed on each face of the polyhedron. The user of the HMD 100 makes a predetermined gesture and thus can select (decide) a face of the operation GUI 500 and execute a selected function of the navigation device Nay.

Specifically, in the example shown in FIG. 8, the user of the HMD 100 puts the right hand RH on the steering wheel HD and selects a face of navigation on the operation GUI 500 with the forefinger of the left hand LH. The user of the HMD 100 can execute a “navigation” menu by making the gesture of pressing the face where “navigation” is displayed, of the operation GUI 500, with a fingertip of the left hand LH. Details of the configuration of the operation GUI 500 will be described later.

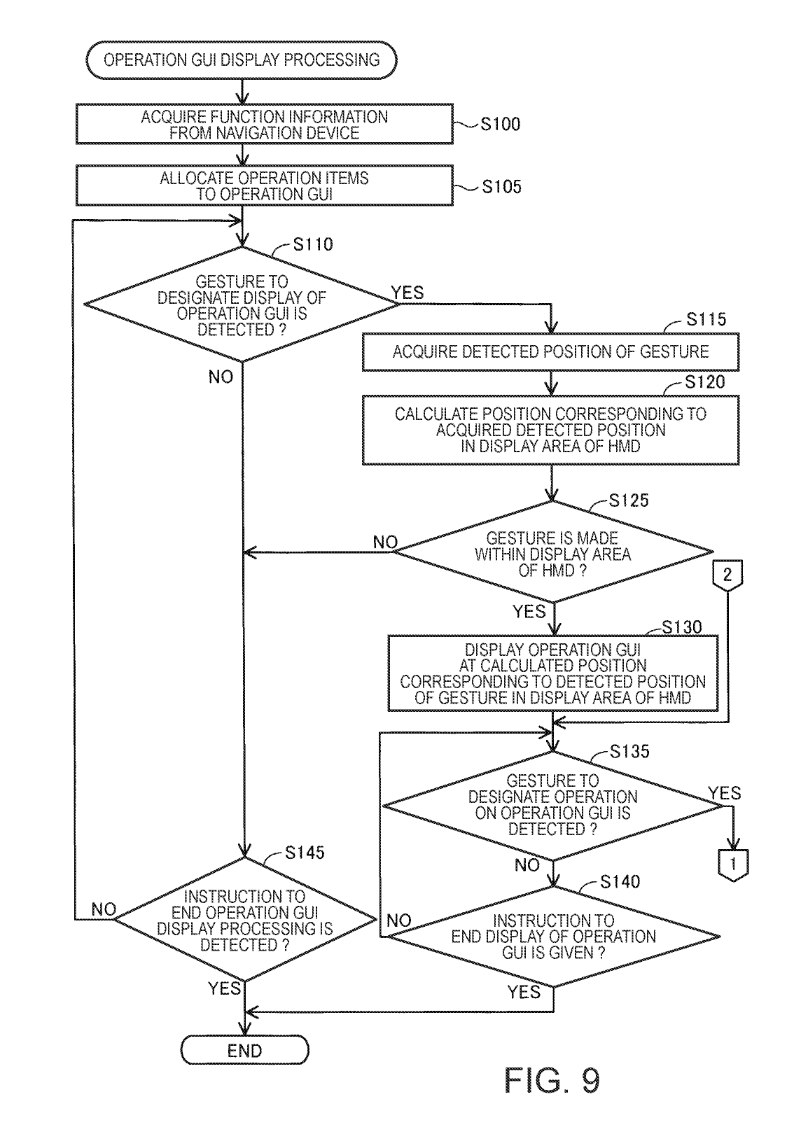

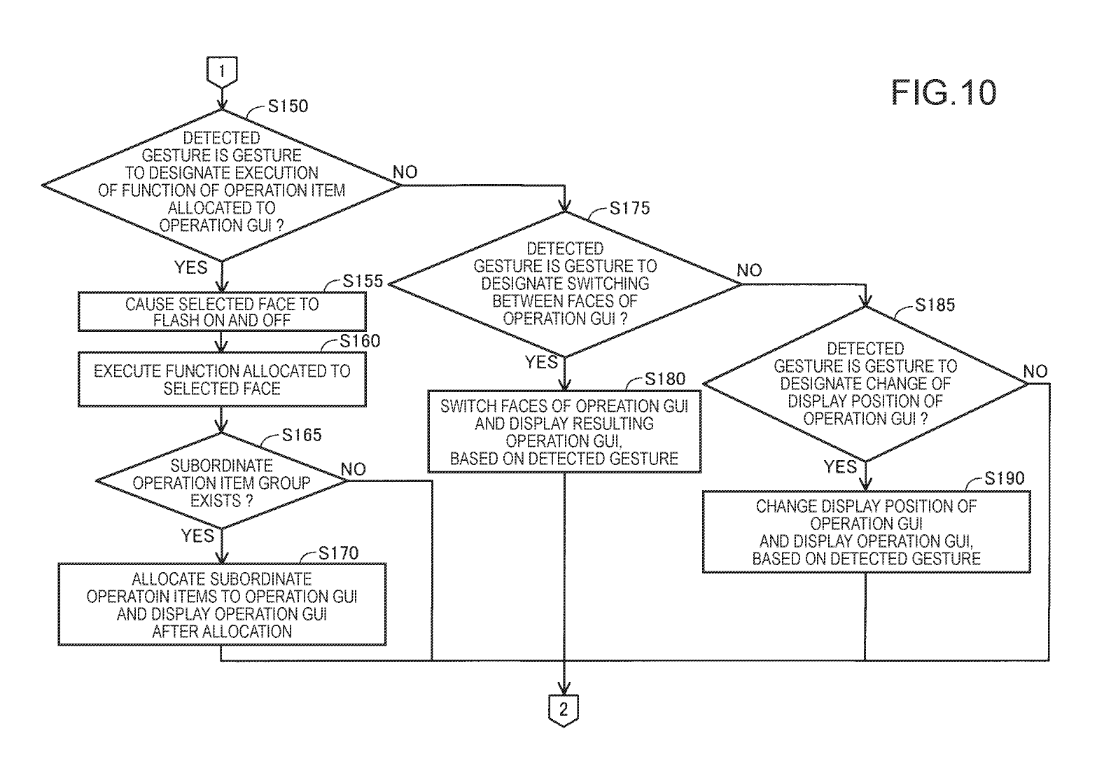

FIGS. 9 and 10 are flowcharts showing processing procedures of the operation GUI display processing. The operation GUI display processing is started, triggered by the completion of connection between the navigation device Nav and the HMD 100. As shown in FIG. 9, the function information acquisition unit 155 acquires function information from the navigation device Nav (Step S100).

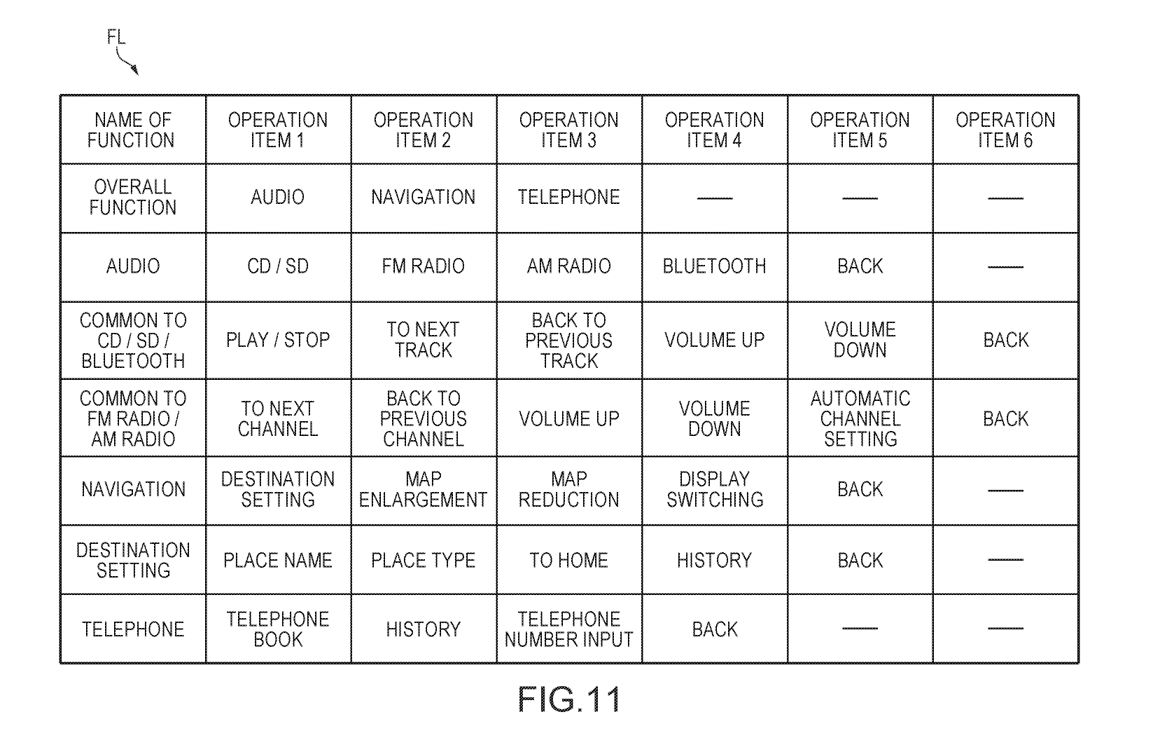

FIG. 11 is an explanatory view showing an example of the function information acquired from the navigation device Nay. The function information FL is stored in advance in a memory area of the navigation device Nay. The function information acquisition unit 155 acquires the function information FL, referring to the memory area of the navigation device Nay. As shown in FIG. 11, the function information FL includes function names and operation items. In FIG. 11, function names are shown in the leftmost column, and operation items are shown in the other columns than the leftmost column. In the embodiment, the “operation items” refers to functions executed in association with the functions presented in the leftmost column. That is, the functions presented in the leftmost column are overall functions that cover each operation item, and are equivalent to a main menu of each operation item. Meanwhile, each operation item is a part of the functions presented in the leftmost column and is equivalent to a sub-menu.

Specifically, the “overall function” shown in the second row from the top in FIG. 11 is a list of operation items of all the functions installed in the navigation device Nay. The operation items of the “overall function” are “audio”, “navigation”, and “telephone”. The “audio” shown in the third row from the top in FIG. 11 is a list of operation items of the “audio”, of the “overall function”. The operation items of the “audio” are “CD/SD”, “FM radio”, “AM radio”, “Bluetooth”, and “back”. In this way, if an operation item presented in an upper row of the function information FL is associated with another operation item, this operation item (hereinafter referred to as “subordinate operation item”) is acquired as well. The “back” means going back from a subordinate operation item to a superordinate operation item. For example, the “back” as an operation item of the “audio” means going back to the “overall function”.

In the embodiment, a degree of priority is set in advance for each of the operation items 1 to 6. The degree of priority corresponds to the order of allocation in allocating the operation items to the operation GUI 500. The highest degree of priority is set for the operation item 1. The degree of priority subsequently drops in order of the operation item 2, the operation item 3, and the like. The lowest degree of priority is set for the operation item 6.

As shown in FIG. 9, after the execution of Step S100, the display control unit 147 allocates the operation items to the operation GUI 500 (Step S105).

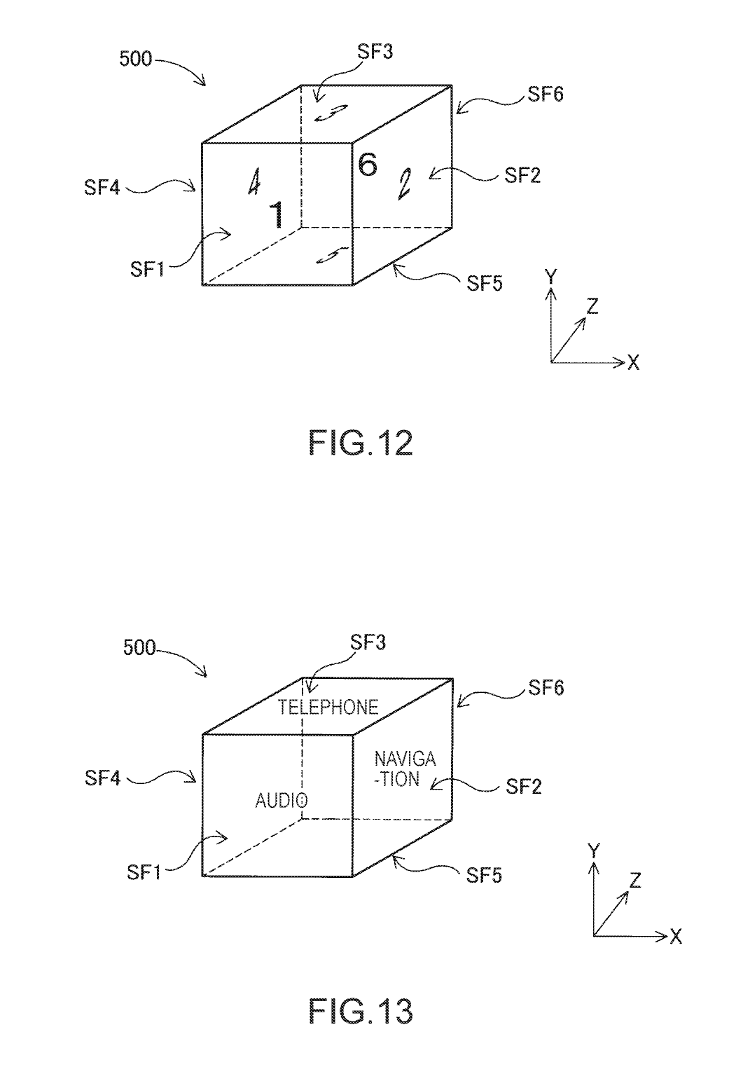

FIG. 12 is an explanatory view schematically showing a schematic configuration of the operation GUI 500. In FIG. 12, for the sake of convenience of the description, faces that the user cannot visually recognize when the operation GUI 500 is displayed on the HMD 100 are illustrated as a perspective view. As shown in FIG. 12, the operation GUI 500 is in the shape of a regular hexahedron and is made up of a first face SF1, a second face SF2, a third face SF3, a fourth face SF4, a fifth face SF5, and a sixth face SF6. The first face SF1 is a face on the side of the −Z direction of the operation GUI 500 and is displayed facing the user of the HMD 100. The second face SF2 is a face on the side of the +X direction of the operation GUI 500. The fourth face SF4 is a face on the side of the −X direction of the operation GUI 500. The third face SF3 is a face in the +Y direction of the operation GUI 500. The fifth face SF5 is a face in the −Y direction of the operation GUI 500. In the embodiment, the fourth face SF4, the fifth face SF5, and the sixth face SF6 are not visually recognized by the user when the operation GUI 500 is displayed on the HMD 100. Also, the first face SF1, the second face SF2, and the third face SF3 may be displays as light-transmissive so that the user can visually recognize the fourth face SF4, the fifth face SF5, and the sixth face SF6.

As described above, the degrees of priority are set for the respective operation items of the function information FL. Numbers 1 to 6 on the respective faces of the operation GUI 500 shown in FIG. 12 univocally correspond to the degrees of priority. Therefore, in Step S105, the operation items are allocated to the operation GUI 500 in such away that the numbers 1 to 6 on the respective faces and the degrees of priority of the operation items coincide with each other. Specifically, the operation item 1 is allocated to the first face SF1. The operation item 2 is allocated to the second face SF2. The operation item 3 is allocated to the third face SF3. The operation item 4 is allocated to the fourth face SF4. The operation item 5 is allocated to the fifth face SF5. The operation item 6 is allocated to the sixth face SF6.

FIG. 13 is an explanatory view schematically showing the state where the operation items of the “overall function” are allocated to the operation GUI 500. In FIG. 13, as in FIG. 12, for the sake of convenience of the description, the left lateral face, the bottom face, and the face on the forward side, which are not visually recognized by the user when the operation GUI 500 is displayed, are illustrated as a perspective view. As shown in FIG. 13, the operation item 1 “audio” is allocated to the first face SF1. The operation item 2 “audio” is allocated to the second face SF2. The operation item 3 “telephone” is allocated to the third face SF3. Since the “overall function” has the three operation items, that is, the operation items 1 to 3, as shown in FIG. 11, nothing is displayed on the fourth face SF4, the fifth face SF5, and the sixth face SF6, as shown in FIG. 13.

As shown in FIG. 9, after the execution of Step S105, the operation detection unit 157 determines whether a gesture to designate the display of the operation GUI 500 is detected or not (Step S110). In the embodiment, the “gesture to designate the display of the operation GUI 500” means a change in the shape of one of the hands of the user of the HMD 100 from a clenched state (so-called “rock” as in rock-paper-scissors) to an open state (so-called “paper”). Specifically, first, the image pickup control unit 149 causes the camera 61 to pick up an image over the field of vision VR of the user and acquires the picked-up image. When the picked-up image is acquired, the operation detection unit 157 analyzes the picked-up image and determines whether the shape of one of the hands of the user of the HMD 100 is changed from the state of “rock” to the state of “paper” or not.

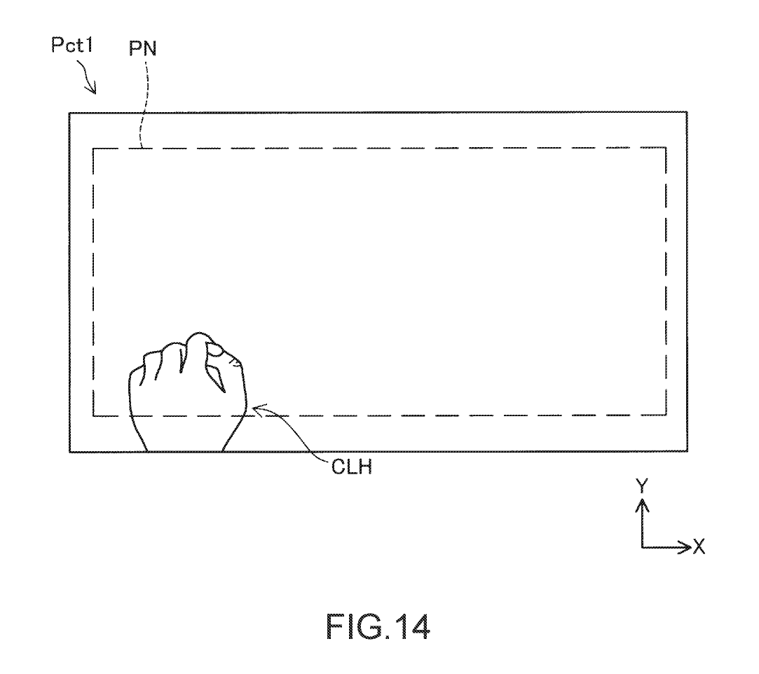

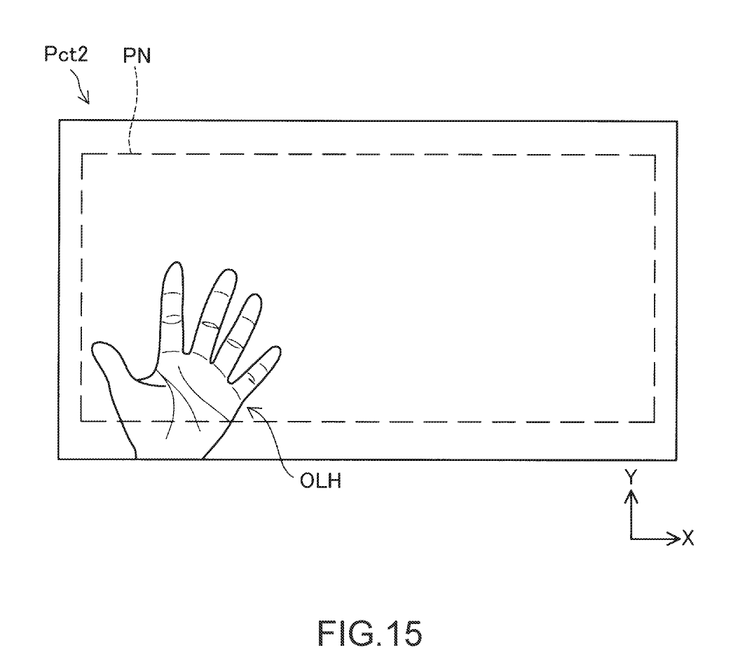

FIGS. 14 and 15 are explanatory views schematically showing an example of the picked-up image. FIG. 14 shows a picked-up image Pct1 showing the state where the left hand of the user of the HMD 100 is in the shape of “rock”. FIG. 15 shows a picked-up image Pct2 showing the state where the left hand of the user of the HMD 100 is in the shape of “paper”. In FIGS. 14 and 15, for the sake of convenience of the description, only the left hand of the user of the HMD 100 is illustrated. Also, in FIGS. 14 and 15, for the sake of convenience of the description, the display area PN of the HMD 100 is shown. In Step S110, the operation detection unit 157 analyzes the picked-up image and detects the shape of the hand at each predetermined timing. The operation detection unit 157 stores the previously detected shape of the hand, and determines that the gesture that designates the display of the operation GUI is detected if the detected shape of the hand is changed from the state of “rock” to the state of “paper”.

For example, the operation detection unit 157 analyzes the picked-up image Pct1 shown in FIG. 14 and thus detects the shape of the left hand CLH in the state of “rock”. After that, the operation detection unit 157 analyzes the picked-up image Pct2 shown in FIG. 15, thus detects the shape of the left hand OLH in the state of “paper”, and determines that the gesture to designate the display of the operation GUI 500 is detected because the detected shape of the hand is changed from the state of “rock” to the state of “paper”.

As shown in FIG. 9, if the gesture to designate the display of the operation GUI 500 is detected (YES in Step S110), the operation detection unit 157 acquires the detected position of the gesture (Step S115). Specifically, the operation detection unit 157 detects the X-coordinate and the Y-coordinate of the position of the centroid of the left hand OLH in the state of “paper”, using the picked-up image Pct2 shown in FIG. 15. In the embodiment, the “position” means the position of the centroid of the hand in the state of “paper” when a change in the shape of the hand from the state of “rock” to the state of “paper” is detected. In other words, it means the position of the centroid of the hand detected after the detected shape of the hand is changed.

As shown in FIG. 9, after the execution of Step S115, the operation detection unit 157 calculates a position corresponding to the detected position acquired in the display area PN of the HMD 100 (Step S120). As shown in FIG. 8, of the field of vision VR of the user, the display area PN is an area that is more to the inside than an image pickup area RA1. Therefore, if the gesture is detected in the area excluding the display area PN from the image pickup area RA1 and the user tries to display the operation GUI 500 at that detected position, the operation GUI 500 is not displayed because it is not in the display area PN. In the embodiment, the display position of the operation GUI 500 is defined as a relative position to the detected position of the gesture in the image pickup area RA1 as a reference position. As an example, in Step S120, the coordinates of a position shifted by a predetermined distance from the detected position of the gesture in the image pickup area RA1 toward the display area PN are calculated. Also, for example, the coordinates of a position in the display area PN that is the closest to the detected position of the hand making the gesture in the image pickup area RA1 and where operation GUI 500 can be displayed without overlapping the hand making the gesture may be calculated. Moreover, for example, if the detected position of the gesture is within the image pickup area RA1 and within the display area PN1, the coordinates of a position overlapping the hand making the gesture may be calculated, or the coordinates of a position that is a predetermined distance away from the hand making the gesture may be calculated.

As shown in FIG. 9, after the execution of Step S120, the display control unit 147 determines whether the gesture is made within the display area PN of the HMD 100 or not (Step S125). Specifically, the display control unit 147 determines whether the coordinates calculated in Step S120 are included in the display area PN or not. If the coordinates calculated in Step S120 are included in the display area PN, it is determined that the gesture is made within the display area PN of the HMD 100. Meanwhile, if the coordinates calculated in Step S120 are not included in the display area PN, it is determined that the gesture is not made within the display area PN of the HMD 100.

If it is determined that the gesture is not made within the display area PN of the HMD 100 (NO in Step S125), Step 145, described later, is executed. Meanwhile, if it is determined that the gesture is made within the display area PN of the HMD 100 (YES in Step S125), the display control unit 147 displays the operation GUI 500 at the position calculated in Step S120 (Step S130).

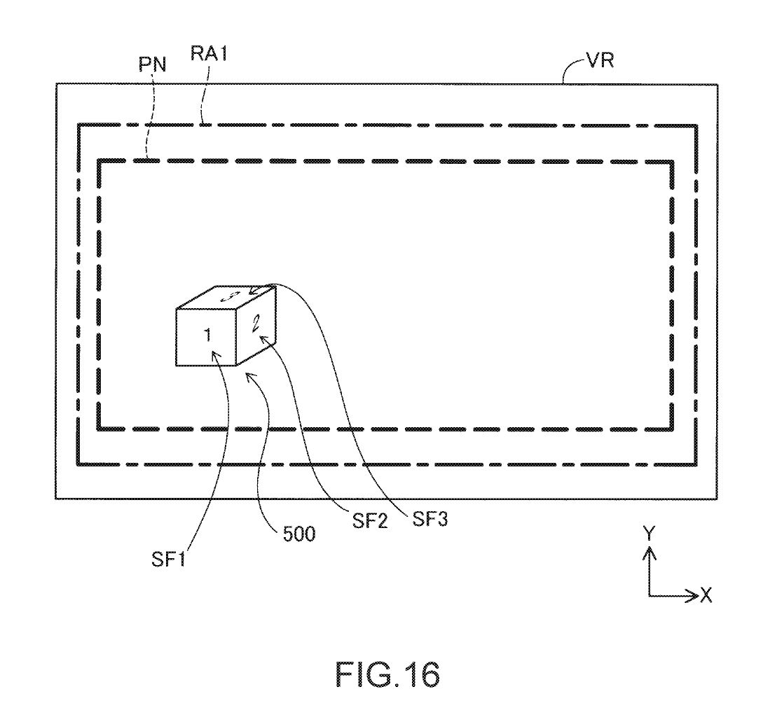

FIG. 16 is an explanatory view schematically showing the operation GUI 500 displayed on the image display unit 20. On the operation GUI 500 shown in FIG. 16, for the sake of convenience of the description, the illustration of the function names shown in the function information FL is omitted and the face numbers on the polyhedron are shown. As described above, the operation GUI 500 is displayed in such a way that the first face SF1 faces the user of the HMD 100. Also, the operation GUI 500 is displayed in such a way that the second face SF2 faces to the right as viewed from the user of the HMD 100 and that the third face SF3 faces vertically upward. Moreover, the operation GUI 500 is displayed at a position shifted by a predetermined distance in the +Y direction and in the +X direction from the position of the centroid of the left hand OLH in the state of “paper”, which is the detected position of the gesture shown in FIG. 15.

As shown in FIG. 9, after the execution of Step S130, the operation detection unit 157 determines whether a gesture to designate an operation on the operation GUI 500 is detected or not (Step S135). In the embodiment, the “operation on the operation GUI 500” refers to each operation of the execution of the function of an operation item allocated to the operation GUI 500, the switching between faces of the operation GUI 500, the change of the display position of the operation GUI 500, and the switching between a plurality of operation GUIs 500. Gestures to designate these operations are defined in advance in the operation detection unit 157. In the embodiment, the following gestures are employed.

Specifically, the gesture to designate the execution of the function of an operation item allocated to the operation GUI 500 is pressing the first face SF1 with one finger in the state where the operation item to be executed is displayed on the first face SF1. The gesture to designate the switching between faces of the operation GUI 500 is moving the four fingers other than the thumb in the direction in which the faces are to be switched. The gesture to designate the changing of the display position of the operation GUI 500 is pinching the operation GUI 500 with two fingers. The gesture to designate the switching between a plurality of operation GUIs 500 is moving up and down a hand in the state of “paper”. Each gesture will be described in detail later.

In Step S135, the operation detection unit 157 determines whether one of the gestures to designate operations on the operation GUI 500 is detected or not. Specifically, as in Step S110, the operation detection unit 157 analyzes the picked-up image and thus detects the shape of the hand, and determines that a gesture to designate an operation on the operation GUI 500 is detected, if a shape of the hand corresponding to one of the gestures to designate operations on the operation GUI 500 is detected. Meanwhile, if a shape of the hand corresponding to one of the gestures to designate operations on the operation GUI 500 is not detected, the operation detection unit 157 determines that a gesture to designate an operation on the operation GUI 500 is not detected.

If it is determined that a gesture to designate an operation on the operation GUI 500 is detected (YES in Step S135), the operation detection unit 157 determines whether the detected gesture is the gesture to designate the execution of the function of an operation item allocated to the operation GUI 500, or not (Step S150), as shown in FIG. 10.

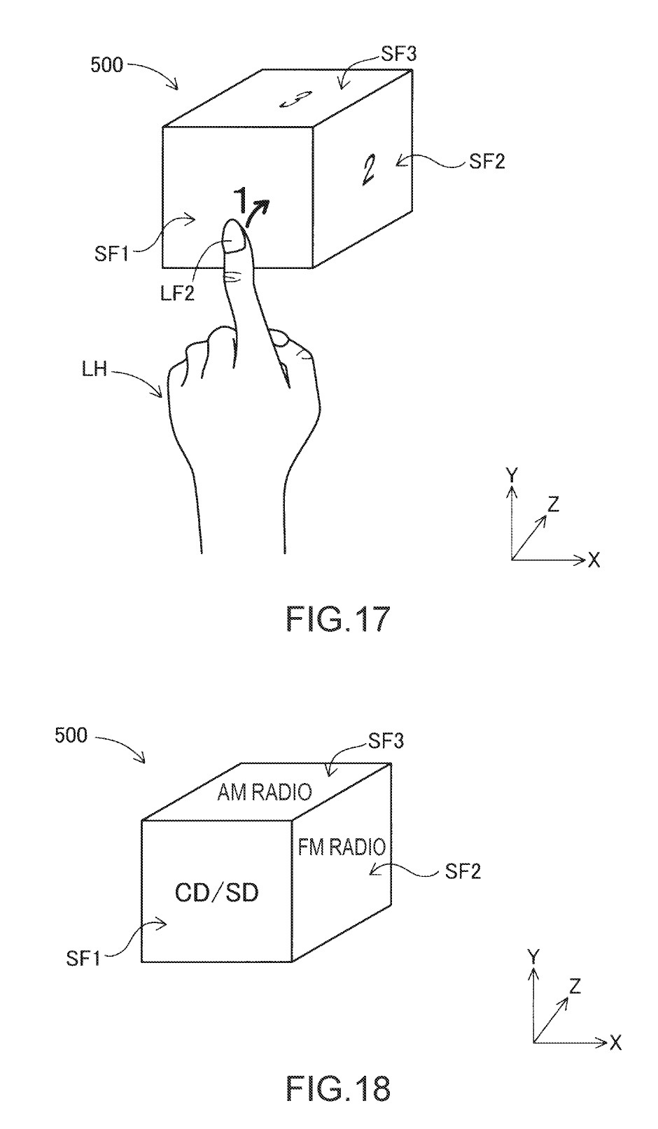

FIG. 17 is an explanatory view schematically showing the execution of the function of an operation item allocated to the operation GUI 500. On the operation GUI 500 shown in FIG. 17, for the sake of convenience of the description, the illustration of the function names shown in the function information FL is omitted and the face numbers on the polyhedron are shown. In the embodiment, the operation GUI 500 is configured in such a way that only the operation item displayed on the face facing the user, that is, the first face SF1, can be executed. In the state shown in FIG. 17, the function of the operation item allocated to the first face SF1 can be executed. Meanwhile, if the user wishes to execute the functions of the operation items allocated to the second face SF2 and the third face SF3, the user first needs to switch faces of the operation GUI 500 so that the intended face faces the user of the HMD 100 and then make the gesture to designate the execution of the function.

As described above, the gesture to designate the execution of the function of an operation item allocated to the operation GUI 500 is pressing the first face SF1 with one finger in the state where the operation item to be executed is displayed on the first face SF1. As shown in FIG. 17, the user of the HMD 100 can execute the function of the operation item allocated to the first face SF1 by making the gesture of pressing the first face SF1 with the fingertip of the forefinger LF2 of the left hand LH. In Step S150, the operation detection unit 157 analyzes the picked-up image and detects a change in the shape of the forefinger LF2 of the left hand LH or the shape of the left hand LH, and thus determines whether the detected gesture is the gesture to designate the execution of the function of an operation item allocated to the operation GUI 500 or not.

As shown in FIG. 10, if it is determined that the detected gesture is the gesture to designate the execution of the function of an operation item allocated to the operation GUI 500 (YES in Step S150), the display control unit 147 causes the selected face to flash on and off (Step S155). This is to notify the user of the HMD 100 that the execution of the operation item allocated to the selected face is to start. After the execution of Step S155, the display control unit 147 executes the function allocated to the selected face (Step S160). Specifically, the display control unit 147 controls the communication control unit 153 to transmit a command to execute the function to the navigation device Nay.

As shown in FIG. 10, after the execution of Step S160, the display control unit 147 determines whether there is a subordinate operation item group or not (Step S165). Specifically, the display control unit 147 determines whether there is a subordinate operation item group allocated to the selected face or not, referring to the function information FL shown in FIG. 11. If it is determined that there is a subordinate operation item group (YES in Step S165), the display control unit 147 allocates subordinate operation items to the operation GUI 500 and displays the operation GUI 500 after the allocation (Step S170).

FIG. 18 is an explanatory view schematically showing the operation GUI 500 after the execution of Step S170. The operation GUI 500 shown in FIG. 18 is in the state where the operation item “audio” allocated to the first face SF1 of the operation GUI 500 shown in FIG. 13 is executed in Step S160. As described above, the operation item “audio” has the subordinate operation items of “CD/SD”, “FM radio”, “AM radio”, “Bluetooth”, and “back”. Therefore, “CD/SD”, “FM radio”, “AM radio”, “Bluetooth”, and “back”, forming the subordinate operation item group, are allocated in this order to the first face SF1 to the fifth face SF5. Subsequently, the operation GUI 500 after the allocation of the subordinate operation items is displayed, as shown in FIG. 18.

As shown in FIG. 10, if it is determined that there is no subordinate operation item group (NO in Step S165), the processing returns to before the execution of the Step S135 and Step S135 is executed again.

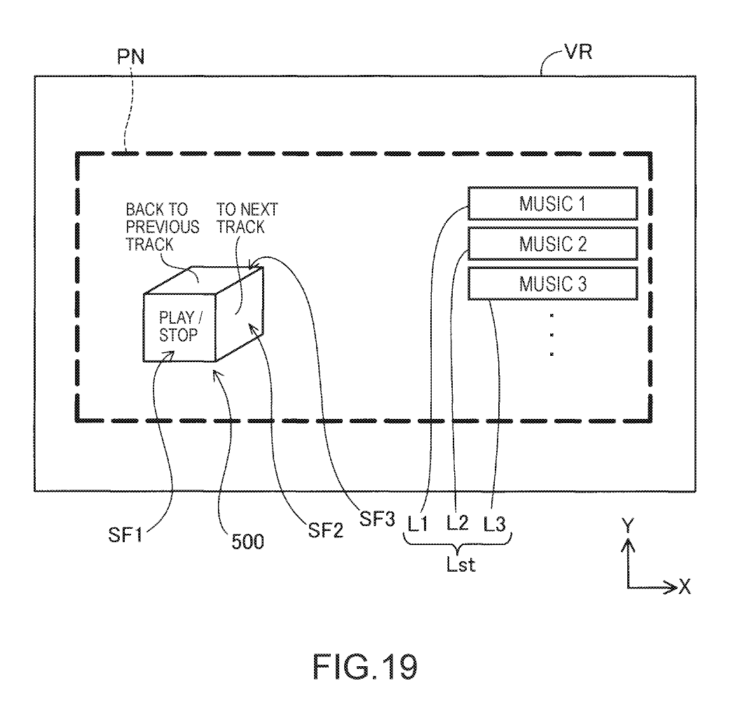

FIG. 19 is an explanatory view schematically showing the field of vision VR of the user after the execution of Step S170. The operation GUI 500 shown in FIG. 19 is in the state where the operation item “CD/SD” allocated to the first face SF1 of the operation GUI 500 shown in FIG. 18 is selected and its function is thus executed. As shown in FIG. 19, the operation GUI 500 and a music list Lst are displayed in the display area PN. The music list Lst is displayed in an area where the operation GUI 500 is not displayed, in the display area PN.

As shown in FIG. 11, a subordinate operation item group is allocated to the operation item “CD/SD”. Therefore, the subordinate operation items of the operation item “CD/SD” are newly allocated to and displayed on the operation GUI 500, as shown in FIG. 19. Specifically, an operation item “play/stop” is allocated to the first face SF1. An operation item “to next track” is allocated to the second face SF2. An operation item “back to previous track” is allocated to the third face SF3. The music list Lst is information related to the operation item “CD/SD”. Specifically, it is a list of music tracks recorded on a CD or SD. As shown in FIG. 19, the music list Lst shows a plurality of music pieces L1, L2, and L3. The user of the HMD 100 select and play a music piece from the music list Lst by making a gesture to designate an operation on the operation GUI 500.

As shown in FIG. 10, if it is determined in Step S150 that the detected gesture is not the gesture to designate the execution of the function of an operation item allocated to the operation GUI 500 (NO in Step S150), the operation detection unit 157 determines whether the detected gesture is the gesture to designate the switching between faces of the operation GUI 500 or not (Step S175).

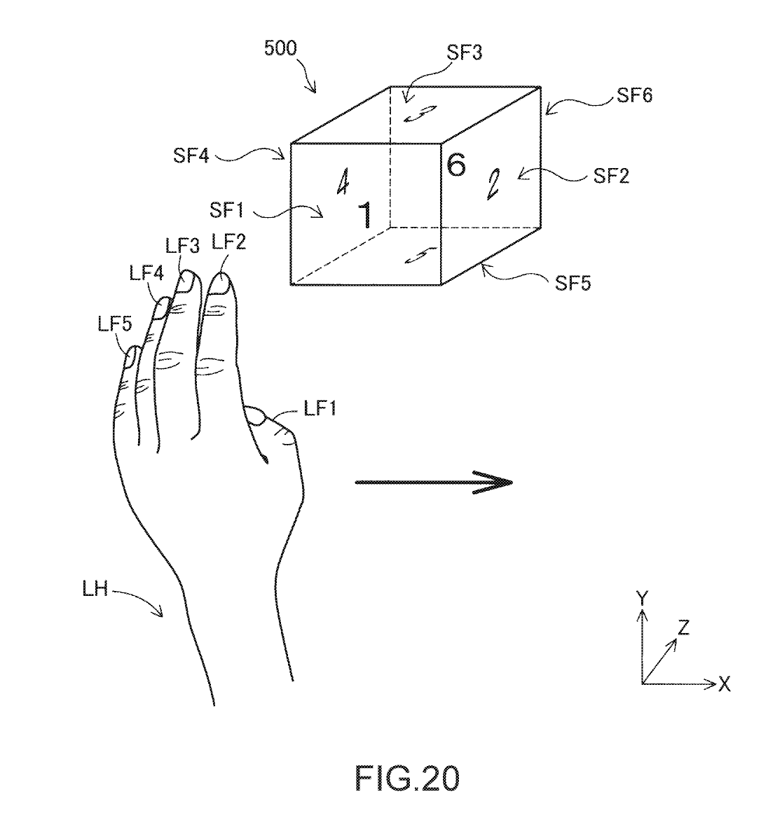

FIG. 20 is an explanatory view schematically showing the gesture to designate the switching between faces of the operation GUI 500. On the operation GUI 500 shown in FIG. 20, as on the operation GUI 500 shown in FIG. 17, the illustration of the function names shown in the function information FL is omitted and the face numbers on the polyhedron are shown. As described above, the gesture to designate the switching between faces of the operation GUI 500 is moving the four fingers other than the thumb in the direction in which the faces are to be switched. As shown in FIG. 20, the user of the HMD 100 moves the four fingers LF2 to LF5 other than the thumb LF1 of the left hand LH in the +X direction. In Step S175, the operation detection unit 157 analyzes the picked-up image and detects the shape of the left hand LH, and thus determines whether the shape of the hand is in the state where the four fingers other than the thumb LF1 are moved in a predetermined direction or not. If it is determined that the detected shape of the left hand LH is in the state where the four fingers other than the thumb LF1 are moved in a predetermined direction, it is then determined that the gesture to designate the switching between faces of the operation GUI 500 is detected. Meanwhile, if it is determined that the detected shape of the left hand LH is not in the state where the four fingers other than the thumb LF1 are moved in a predetermined direction, it is then determined that the gesture to designate the switching between faces of the operation GUI 500 is not detected.

As shown in FIG. 10, if it is determined in Step S175 that the gesture to designate the switching between faces of the operation GUI 500 is detected (YES in Step S175), faces of the operation GUI 500 are switched and the resulting operation GUI 500 is displayed, based on the detected gesture (Step S180).

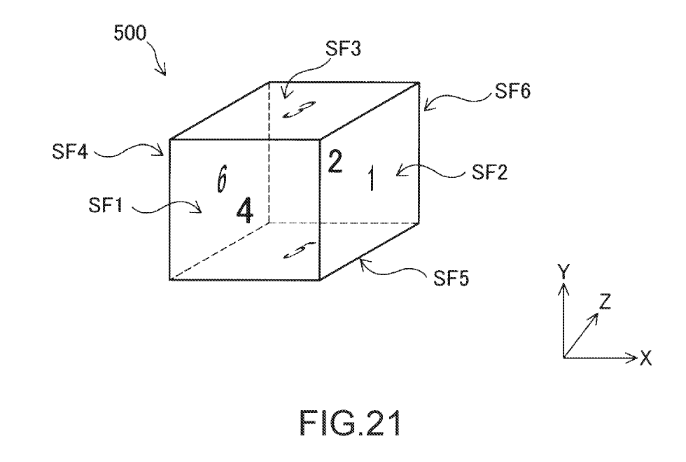

FIG. 21 is an explanatory view schematically showing the operation GUI 500 after the execution of Step S180. The operation GUI 500 shown in FIG. 21 is displayed in the state where faces of the operation GUI 500 are switched by the gesture to designate the switching between faces in the +X direction as shown in FIG. 20. To enable understanding by comparing FIGS. 12, 20 and 21, the operation GUI 500 after the switching is displayed as rotated about the Y-axis in direction of the movement of the left hand LH. Specifically, the fourth face SF4 before the switching is displayed on the first face SF1 after the switching. Also, the first face SF1 before the switching is displayed on the second face SF2 after the switching. The second face SF2 before the switching is displayed on the sixth face SF6 after the switching. The sixth face SF6 before switching is displayed on the fourth face SF4 after the switching.

The switching between faces of the operation GUI 500 can be done in each of the X direction and the Y direction. Although not illustrated, for example, if the operation GUI 500 shown in FIG. 20 is switched in the −Y direction, that is, if the third face SF3 is switched to the display position of the first face SF1, the left hand LH is moved in the −Y direction. As this gesture is detected, the third face SF3 is displayed as switched to the display position of the first face SF1.

As shown in FIG. 10, if it is determined in Step S175 that the detected gesture is not the gesture to designate the switching between faces of the operation GUI 500 (NO in Step S175), the operation detection unit 157 determines whether the detected gesture is the gesture to designate the changing of the display position of the operation GUI 500 or not (Step S185).

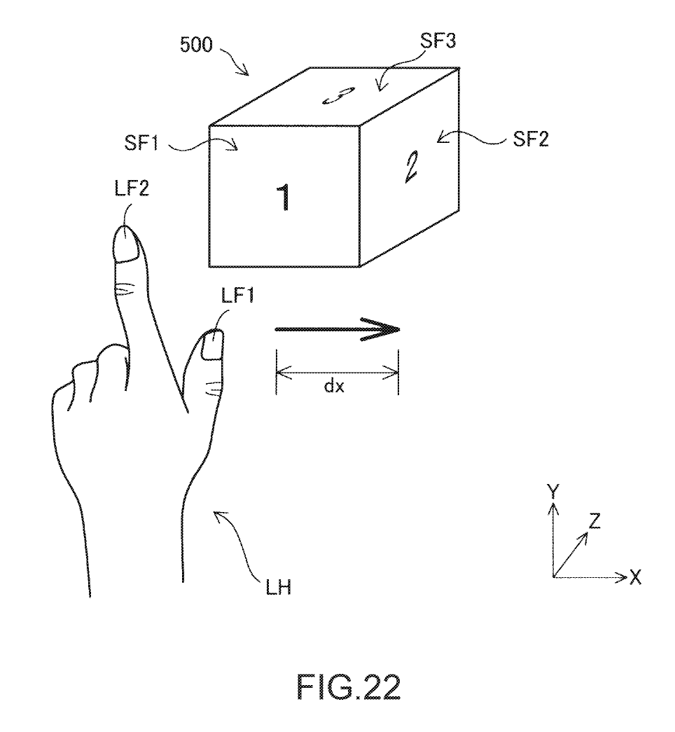

FIG. 22 is an explanatory view schematically showing the gesture to designate the changing of the display position of the operation GUI 500. On the operation GUI 500 shown in FIG. 22, as on the operation GUI 500 shown in FIG. 17, the illustration of the function names shown in the function information FL is omitted and the face numbers on the polyhedron are shown. As described above, the gesture to designate the changing of the display position of the operation GUI 500 is pinching the operation GUI 500 with two fingers.

Specifically, as shown in FIG. 22, the user of the HMD 100 translates the operation GUI 500 by a distance dx in the +X direction by making the movement of pinching the operation GUI 500 with the two fingers of the thumb LF1 and the forefinger LF2 of the left hand LH. In Step S185, the operation detection unit 157 analyzes the picked-up image, detects the shape of the left hand LH, and determines whether the shape of the two fingers is the shape of pinching the operation GUI 500 or not. If the detected shape of the two fingers is the shape of pinching the operation GUI 500, it is determined that the gesture to designate the changing of the display position of the operation GUI 500 is detected. Meanwhile, if the detected shape of the two fingers is not the shape of pinching the operation GUI 500, it is determined that the gesture to designate the changing of the display position of the operation GUI 500 is not detected.

As shown in FIG. 10, if it is determined that the gesture to designate the changing of the display position of the operation GUI 500 is detected (YES in Step S185), the display control unit 147 changes the display position of the operation GUI 500 and displays the operation GUI 500, based on the detected gesture (Step S190).

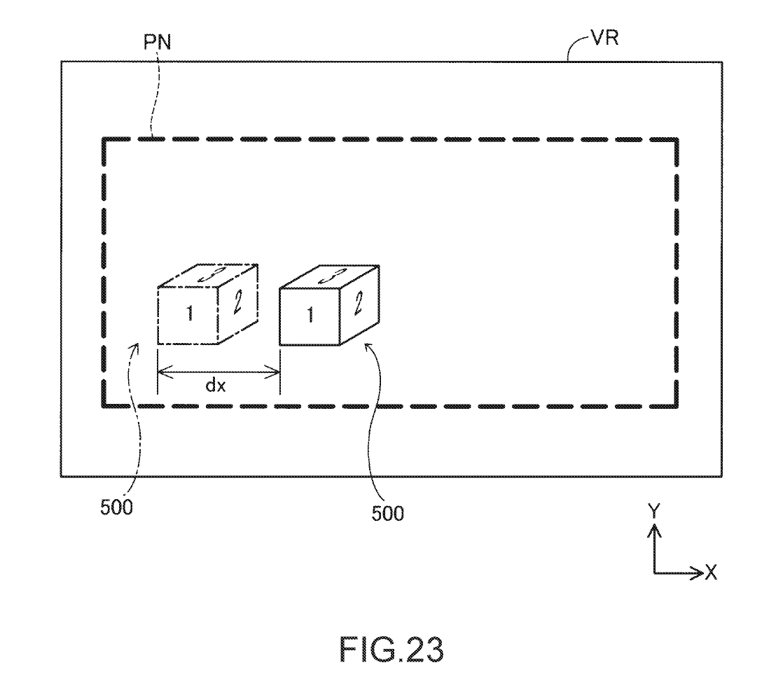

FIG. 23 is an explanatory view schematically showing the field of vision VR of the user after the execution of Step S190. In FIG. 23, the operation GUI 500 after the execution of Step S190 is indicated by solid lines, and the operation GUI 500 before the execution of Step S190 is indicated by dot-dashed lines. As shown in FIG. 23, the bottom left corner of each operation GUI 500 is defined as a reference point, and the reference point of the operation GUI 500 after the execution of Step S190 is shifted by the distance dx in the +X direction from the reference point of the operation GUI 500 before the execution of Step S190.

As shown in FIG. 10, after the execution of Step S190, the processing returns to before the execution of Step S135 shown in FIG. 9 and Step 135 is executed again.

As shown in FIG. 10, if it is determined in Step S185 that the gesture to designate the changing of the display position of the operation GUI 500 is not detected (NO in Step S185), the processing returns to before the execution of Step S135 and Step 135 is executed again, similarly to after the execution of Step S190.

As shown in FIG. 9, if it is determined in Step S135 that a gesture to designate an operation on the operation GUI 500 is not detected (NO in Step S135), the operation detection unit 157 determines whether an instruction to end the display of the operation GUI 500 is given or not (Step S140). Specifically, the operation detection unit 157 measures the time during which a gesture to designate an operation on the operation GUI 500 is not detected after the operation GUI 500 is displayed. If this time exceeds a predetermined time, it is determined that an instruction to end the display of the operation GUI 500 is given. Meanwhile, if the measured time does not exceed the predetermined time, it is determined that an instruction to end the display of the operation GUI 500 is not given.

If the instruction to end the display of the operation GUI 500 is given (YES in Step S140), the operation GUI display processing ends. Meanwhile, if an instruction to end the display of the operation GUI 500 is not given (NO in Step S140), the processing returns to before the execution of Step S135 and S135 is executed again.

If it is determined in Step S110 that the gesture to designate the display of the operation GUI 500 is not detected (NO in Step S110), the display control unit 147 determines whether an instruction to end the operation GUI display processing is detected or not (Step S145).

Specifically, first, the communication control unit 153 acquires the connection state between the HMD 100 and the navigation device Nay. If the acquired connection state is not good, the display control unit 147 determines that an instruction to end the operation GUI display processing is detected. Meanwhile, if the acquired connection state is good, the display control unit 147 determines that an instruction to end the operation GUI display processing is not detected.

If it is determined that an instruction to end the operation GUI display processing is detected (YES in Step S145), the operation GUI display processing ends. Meanwhile, if it is determined that an instruction to end the operation GUI display processing is not detected (NO in Step S145), the processing returns to before the execution of Step S110 and Step S110 is executed again.

The HMD 100 in the embodiment described above includes the display control unit 147, which displays the operation GUI 500 using the function information FL of the navigation device Nav, and the operation detection unit 157, which detects a predetermined gesture of the user of the HMD 100. The display control unit 147 displays the operation GUI 500 at the display position decided according to the position of a detected gesture. Therefore, the function information FL of the navigation device Nav can be drawn together on the operation GUI 500, and the operation GUI 500 can be displayed at the position corresponding to the position where the user makes a gesture. Thus, operability in controlling the HMD 100 can be improved and convenience for the user can be improved.

Since the display position of the operation GUI 500 is decided as a relative position to the position of a detected gesture as a reference position, the operation GUI 500 can be displayed at the position corresponding to the position of the detected gesture. Therefore, the user can predict the display position of the operation GUI 500 or can adjust the display position of the operation GUI 500 on the image display unit 20 by controlling the position of the gesture. In addition, since the operation GUI 500 is displayed in an area excluding a center part of the image display unit 20, the display of the operation GUI 500 can be restrained from blocking the field of vision VR of the user.

Since an operation on the operation GUI 500 is executed according to a detected gesture of the user, the user can execute the content of an operation on the operation GUI 500 by making a gesture associated with the content of the operation on the operation GUI 500. Therefore, convenience for the user can be improved. Also, the function information acquisition unit 155 acquires the function information FL, triggered by the completion of connection between the navigation device Nav and the HMD 100. Therefore, the function information FL can be acquired more securely.

Since the operation GUI 500 is displayed if a detected gesture is a predetermined gesture, the operation GUI 500 can be displayed at a timing desired by the user. Therefore, convenience for the user can be improved. Also, since the operation GUI 500 is displayed if a gesture of the user is detected within the display area PN of the image display unit 20, the display of the operation GUI 500 by detecting an unintended gesture of the user can be restrained. Moreover, since the information related to the function information FL (music list Lst) is displayed in an area where the operation GUI 500 is not displayed, in the display area PN Of the image display unit 20, the user can visually recognize the operation GUI 500 and the information related to the function information FL simultaneously in the display area PN. Therefore, convenience for the user can be improved.

### B. Modifications

### B1. Modification 1

In the embodiment, the shape of the operation GUI 500 is a regular hexahedron. However, the invention is not limited to this. For example, any polyhedral shape such as regular tetrahedron or regular dodecahedron may be employed. Also, not only polyhedral shapes but also other three-dimensional shapes such as cylinder, cone, and sphere may be employed. Such configurations have effects similar to those of the embodiment.

### B2. Modification 2

In the embodiment, one operation GUI 500 is displayed. However, the invention is not limited to this. For example, if the operation GUI 500 is in the shape of a regular hexahedron and the number of operation items is 6 or more, as in the embodiment, two operation GUIs 500 may be displayed side by side.

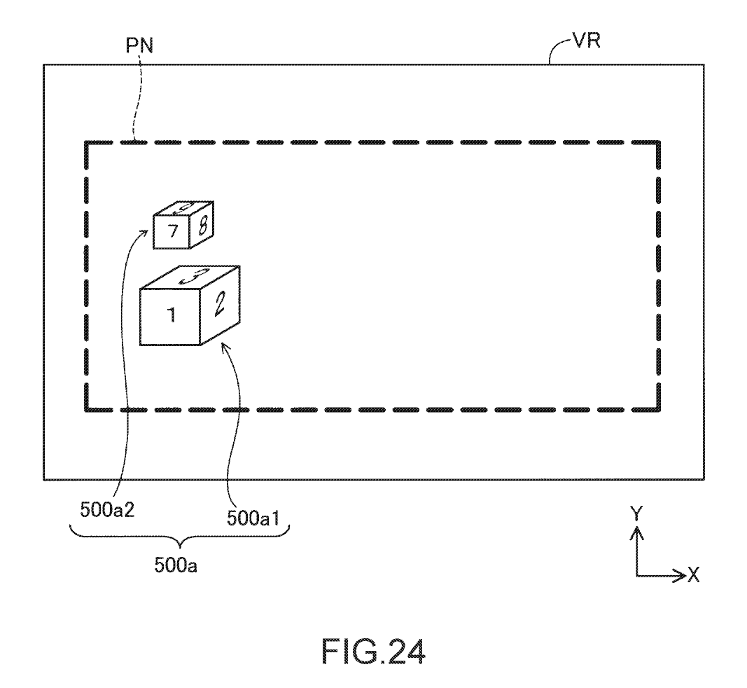

FIG. 24 is an explanatory view schematically showing an operation GUI 500a in Modification 2. The operation GUI 500a includes two operation GUIs 500a1 and 500a2. Operation items 1 to 6 are allocated to the operation GUI 500a1. Operation items 7 to 12 are allocated to the operation GUI 500a2. The operation GUI 500a1 is displayed at the same display position as the operation GUI 500 in the embodiment shown in FIG. 16. The operation GUI 500a2 is displayed further in the +Y direction than the operation GUI 500a1. The operation GUI 500a2 is displayed in a smaller size than the operation GUI 500a1.

The operation GUI 500a in Modification 2, too, is configured to enable execution of only the operation item displayed on the first face SF1, as in the embodiment. Therefore, if the user of the HMD 100 wishes to execute the function of an operation item allocated to the operation GUI 500a2, the user first needs to switch the display positions of the operation GUI 500a1 and the operation GUI 500a2.

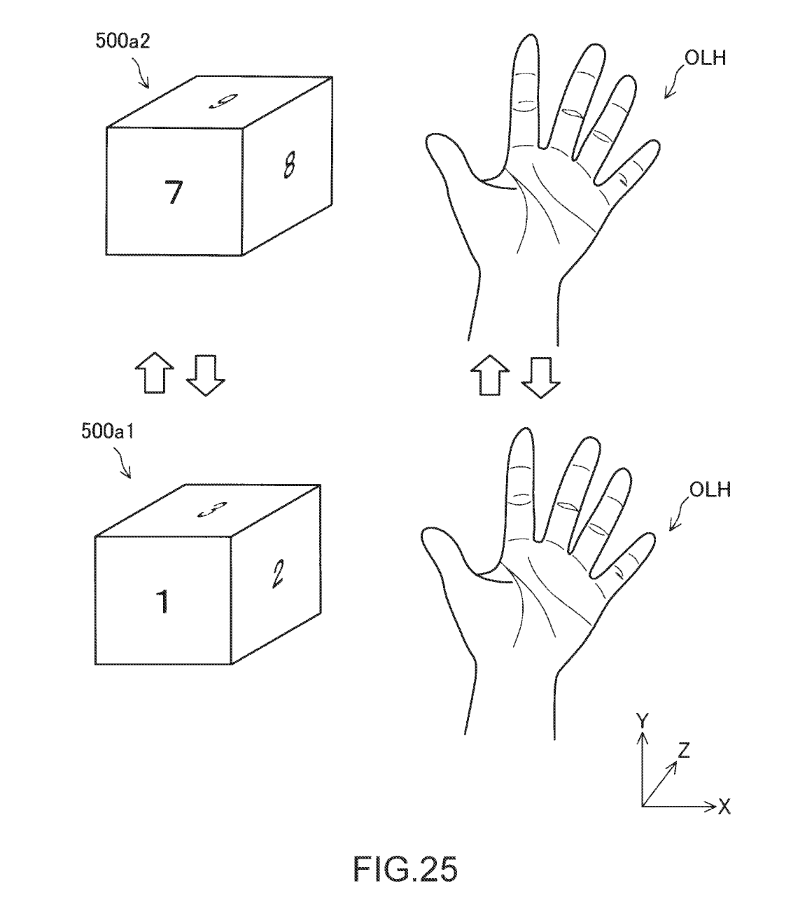

FIG. 25 is an explanatory view schematically showing the gesture to switch the operation GUI 500a in Modification 2. In FIG. 25, for the sake of convenience of the description, the operation GUI 500a2 is shown in the same size as the operation GUI 500a1. As described above, the gesture to designate switching between a plurality of operations GUI 500a is moving up and down the hand in the state of “paper”. If the user of the HMD 100 makes the gesture of moving up and down the left hand OLH in the state of “paper” along the Y direction, as shown on the right-hand side in FIG. 25, the operation detection unit 157 analyzes the picked-up image and detects the shape of the left hand OLH in the state of “paper” moving along the Y direction, and thus determines that the gesture to designate the switching the display positions of the operation GUI 500a2 and the operation GUI 500a1 is detected. If it is determined that the gesture to designate the switching the display positions of the operation GUI 500a2 and the operation GUI 500a1 is detected, the operation GUI 500a2 and the operation GUI 500a1 shown on the left-hand side in FIG. 25 are displayed with their display positions switched, and the operation GUI 500a2 displayed further in the +Y direction is shown in a smaller size than the operation GUI 500a1 displayed further in the −Y direction.

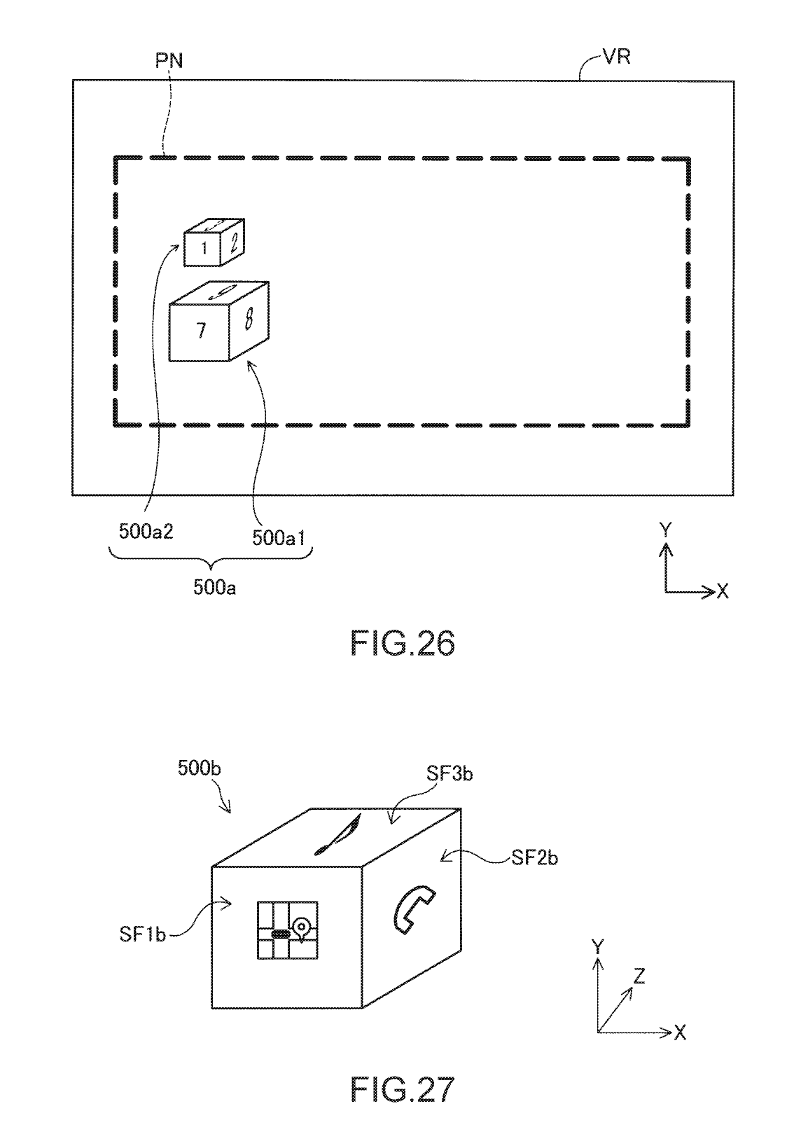

FIG. 26 is an explanatory view schematically showing the operation GUI 500a after the switching. In FIG. 26, the field of vision VR of the user is shown. To enable understanding by comparing FIGS. 24 and 26, the operation GUI 500a2 after the switching of the display positions of the operation GUI 500a1 and the operation GUI 500a2 is displayed at the display position of the operation GUI 500a1 before the switching of the display positions and in the same size as the operation GUI 500a1 before the switching of the display positions. Meanwhile, the operation GUI 500a1 after the switching of the display positions is displayed at the display position of the operation GUI 500a2 before the switching of the display position and in the same size as the operation GUI 500a2 before the switching of the display positions. In this way, the configuration in which a plurality of operation GUIs 500a is simultaneously displayed has effects similar to those of the embodiment.

### B3. Modification 3

In Modification 2, both of the operation GUIs 500a1 and 500a2 are in the shape of a regular hexahedron. However, the operation GUIs 500a1 and 500a2 may be in different shapes from each other. For example, the operation GUI 500a1 may be in the shape of a regular dodecahedron and the operation GUI 500a2 may be in the shape of a regular hexahedron. Even such a configuration has effects similar to those of Modification 2.

### B4. Modification 4

In the embodiment, the function names of the operation items shown in the function information FL are displayed on the respective faces of the polyhedron of the operation GUI 500. However, the invention is not limited to this.

FIG. 27 is an explanatory view schematically showing an operation GUI 500b in Modification 4. On the operation GUI 500b shown in FIG. 27, an image associated in advance with each operation item is displayed. Specifically, an image associated with the operation item “navigation” is displayed on a first face SF1b. An image associated with the operation item “telephone” is displayed on a second face SF2b. An image associated with the operation item “audio” is displayed on a third face SF3b. Even such a configuration has effects similar to those of the embodiment because the functions shown by the function information FL of the navigation device Nav are displayed on the operation GUI 500b.

Moreover, for example, colors may be associated in advance with the functions shown by the function information FL, and the colors may be added to the respective faces of the operation GUI 500. Also, for example, an image and color may be displayed. That is, generally, a configuration in which at least one of image, name and color associated in advance with a function shown by the function information FL is displayed on the operation GUI 500 has effects similar to those of the embodiment. In addition, the user can easily identify the function information FL. Therefore, convenience for the user can be improved.

### B5. Modification 5

In the embodiment, the operation GUI display processing is executed while the user of the HMD 100 is on board a vehicle. However, the invention is not limited to this. The operation GUI display processing may be executed, for example, while the user of the HMD 100 is on board an aircraft. In this case, the function information FL displayed on the operation GUI 500 includes operation items such as in-flight guide and watching movies. Although the function information FL displayed on the operation GUI 500 varies according to the situation where the operation GUI display processing is executed, a gesture of the user of the HMD 100 is detected and the operation GUI 500 is displayed at a display position based on the detected position. Therefore, such a configuration has effects similar to those of the embodiment. Also, the operation GUI display processing may be executed when the user is not on board a moving body such as a vehicle or aircraft. The operation GUI display processing may be executed, for example, in the case where a projector or game machine is operated via the HMD 100.

### B6. Modification 6

In the embodiment, the trigger to end the display of the operation GUI 500 is the case where a gesture to designate an operation on the operation GUI 500 is not detected for a predetermined time after the operation GUI 500 is displayed. However, the invention is not limited to this. For example, “end” may be allocated as an operation item to the operation GUI 500. In this case, the user of the HMD 100 can end the display of the operation GUI 500 by making a gesture to designate the execution of the operation item “end”. Such a configuration has effects similar to those of the embodiment.

### B7. Modification 7

In the embodiment and modifications, gesture input is effective only with the left hand LH and the operation detection unit 157 detects the shape of the left hand LH of the user of the HMD 100. However, the invention is not limited to this. For example, gesture input may be made effective only with the right hand RH of the user of the HMD 100 and the shape of the right hand RH may be detected. Also, the hand to be detected may be decided in advance for each operation target device. As an example, if the operation target device is the navigation device Nav installed on a vehicle, the left hand or the right hand may be predetermined as the hand to be detected and a gesture is made with a hand that is not the predetermined hand or with both hands, it may be determined that a gesture is not detected. Specifically, for example, in Step S110, if the operation detection unit 157 detects that the gesture to designate the display of the operation GUI is made with both hands, the operation detection unit 157 may determine that the gesture to designate the display of the operation GUI is not detected. Also, in this case, since the user has both hands off the steering wheel HD, the display control unit 147 may display a warning. Even with such a configuration, the operation detection unit 157 detects the shape of the hand making a predetermined gesture. Therefore, effects similar to those of the embodiment are achieved.

### B8. Modification 8

In the embodiment, the operation detection unit 157 detects a gesture by analyzing a picked-up image. However, the invention is not limited to this. For example, if the HMD 100 is provided with an infrared sensor, a predetermined gesture may be detected by thermal detection of the shape of the hand. Also, for example, if an operation target device or an on-vehicle device that is different from the operation target device has an image pickup function and is configured to be able to detect gestures, gestures may be detected on the side of the on-vehicle device such as the operation target device. Such a configuration has effects similar to those of the embodiment.

### B9. Modification 9

In the embodiment, the operation GUI 500 is displayed near the bottom left in the display area PN. However, the invention is not limited to this. For example, if the gesture to designate the display of the operation GUI 500 is detected near the top right in the display area PN, the operation GUI 500 may be displayed near the top right in the display area PN. Also, for example, if the gesture to designate the display of the operation GUI 500 is detected at a center part in the display area PN, the operation GUI 500 may be displayed at the center part in the display area PN. That is, generally, any configuration in which the operation GUI 500 is displayed at a display position decided according to the position of a detected gesture has effects similar to those of the embodiment.

### B10. Modification 10

In the embodiment, the function information FL is not limited to the example shown in FIG. 11. For example, the function information FL may include information such as the number of times each operation item is used and a parameter needed for transmitting a function execution command from the HMD 100 to the navigation device Nay. If the function information FL includes the number of times each operation item is used, the display control unit 147 may allocate the operation item used at the highest frequency to the face with the higher degree of priority of the operation GUI 500 and thus allocate operation items in order. Such a configuration has effects similar to those of the embodiment.

### B11. Modification 11

In the embodiment, the display device which executes the operation GUI display processing is the HMD 100. However, the invention is not limited to this. For example, a head-up display (HUD) or a video see-through HMD may be employed. Also, a non-portable transmission-type display device may be employed. Such configurations have effects similar to those of the embodiment.

### B12. Modification 12

In the embodiment and modifications, at least a part of the functions of the display control unit 147 may be executed by another control function unit. Specifically, while the display control unit 147 in the embodiment executes the display of an image with the OLED panels 223, 243 and the operation GUI display processing, for example, another control function unit may execute the operation GUI display processing. A part or the entirety of the functions of these control function units may also be achieved using digital circuits such as CPU, ASIC (application specific integrated circuit), and FPGA (field programmable gate array). Such a configuration has effects similar to those of the embodiment.

### B13. Modification 13

In Modification 2, the display position of the operation GUI 500a2 is further in the +Y direction than the operation GUI 500a1. However, the invention is not limited to this. For example, the operation GUI 500a2 may be displayed further in the −X direction than the operation GUI 500a1 or may be displayed further in the −Y direction than the operation GUI 500a1. Also, for example, the operation GUI 500a2 may be displayed an arbitrary position around the operation GUI 500a1. Moreover, for example, a gesture to designate the display positions of the operation GUIs 500a1, 500a2 may be decided in advance, and the operation GUIs 500a1, 500a2 may be displayed at the display positions designated by the user when such a gesture is detected. Such a configuration has effects similar to those of Modification 2.

### B14. Modification 14

In Modification 2, the operation GUI 500a includes the two operation GUIs 500a1 and 500a2. However, the invention is not limited to this. For example, the operation GUI 500a may include three or more operation GUIs. For example, if there is a plurality of operation target devices, dedicated GUIS to operate the respective operation target devices may be displayed. In this configuration, the operation GUI 500a can be regarded as a set of operation GUIs corresponding to the respective operation target devices. In this configuration, the operation GUI 500a may be displayed after an operation target device connectable to the HMD 100 is found from among the plurality of operation target devices and connected to the HMD 100. Also, the operation target devices may be connected to the HMD 100 in a predetermined order and the operation GUI 500 may be displayed successively for the connected operation target device. Alternatively, every time the user gives an instruction to connect one of the plurality of operation target devices, the operation GUI 500 may be displayed for that operation target device. In this case, the second and subsequent operation GUIs 500 may be displayed in order around the first operation GUI 500 to be displayed, or each operation GUI 500 may be displayed at a position designated by gesture input. Such a configuration has effects similar to those of Modification 2.

### B15. Modification 15

In the embodiment, in Step S155 of the operation GUI display processing, the selected face of the operation GUI 500 flashes on and off. However, the invention is not limited to this. For example, the selected face may be highlighted or may be shaded in color. Also, for example, the image and name displayed on the selected face may flash on and off. Any other display form that can inform the user that the operation item allocated to the selected face is to be executed. Such a configuration has effects similar to those of the embodiment.

### B16. Modification 16

In the embodiment, after the operation GUI 500 is displayed, the display form of the operation GUI 500 may be changed. Specifically, if the speed of movement of the head of the user is equal to or higher than a predetermined speed, the operation GUI 500 may be displayed in a reduced size. Also, for example, the luminance may be reduced or the degree of transmission may be increased. Moreover, for example, pixels at predetermined intervals in the operation GUI 500 may be blackened. Such a configuration has effects similar to those of the embodiment. Also, the operation GUI 500 can be restrained from blocking the field of vision when the head of the user is moving.

### B17. Modification 17

In the embodiment, the entirety of the function information FL is acquired every time the operation GUI display processing is executed. However, the invention is not limited to this. For example, a part of the function information FL may be acquired. Specifically, when the operation target device is connected for the first time, the entirety of the function information FL may be acquired and stored as the setting data 123. Then, the next time the function information FL is acquired from the same operation target device, only the difference from the previously acquired function information FL may be acquired. Such a configuration has effects similar to those of the embodiment.

### B18. Modification 18

In the embodiment, the function information FL is acquired directly from the operation target device. However, the invention is not limited to this. For example, the function information FL may be acquired, accessing a server connected to the internet via a communication carrier. Also, for example, information showing a link of the function information FL of the operation target device may be acquired from a beacon packet or the like transmitted from a wireless LAN device, and the function information FL may be acquired from the link shown by the acquired information. Such a configuration has effects similar to those of the embodiment.

### B19. Modification 19

In the embodiment, the HMD 100 and the navigation device Nav are wirelessly connected to each other. However, the invention is not limited to this. For example, the HMD 100 and the navigation device Nav may be wired to each other. Also, both wired connection and wireless connection may be provided and properly used according to the operation target device and the content of the acquired function information. Moreover, for example, if the operation target device is installed on a vehicle, CAN (controller area network) or the like may be used for communication. Such a configuration has effects similar to those of the embodiment.

### B.20 Modification 20

In the embodiment, the predetermined gesture is not limited to each of the gestures described above. For example, different gestures from the above-described gestures may be set. The user may set a desired gesture in advance. For example, the gesture of turning an open hand from the state of the palm facing down to the state of the palm facing up may be set. Also, the gestures associated with the respective operations on the operation GUI 500 may be different from those in the foregoing example. Such a configuration has effects similar to those of the embodiment.

### B.21 Modification 21

In the embodiment, the operation detection unit 157 detects the predetermined gesture. However, the invention is not limited to this. For example, the operation detection unit 157 may detects a gesture similar to the predetermined gesture. In this case, candidate images of a gesture considered to have been made by the user are displayed and the user is prompted to select one of the candidate images. Then, the operation on the operation GUI 500 associated with the gesture shown in the selected image may be executed, assuming that this gesture is detected. Such a configuration has effects similar to those of the embodiment.

The invention is not limited to the embodiment and modifications and can be realized with various configurations without departing from the spirit and scope of the invention. For example, technical features in the embodiment and modifications corresponding to technical features of each configuration described in the summary section can be replaced or combined where appropriate, in order solve a part or the entirety of the foregoing problems or in order to achieve a part or the entirety of the advantageous effects. Also, such technical features can be deleted where appropriate, unless described as essential in this specification.

The entire disclosure of Japanese Patent Application No. 2017-047530, filed Mar. 13, 2017 is expressly incorporated by reference herein.

What is claimed is:

1. A transmission-type display device comprising:
a light-transmissive image display unit;
a function information acquisition unit which acquires function information of an operation target device;
a display control unit which causes an operation GUI of the operation target device to be displayed, using the acquired function information; and
an operation detection unit which detects a predetermined gesture of a user of the transmission-type display device,
wherein the display control unit causes the operation GUI to be displayed as superimposed on an external field transmitted through the image display unit and visually recognized, at a display position determined according to a position of the detected gesture.

2. The transmission-type display device according to claim 1, wherein
the display position of the operation GUI is determined as a relative position to the position of the detected gesture as a reference.

3. The transmission-type display device according to claim 1, wherein
the display control unit causes the operation GUI to be displayed in an area excluding a center part on the image display unit.

4. The transmission-type display device according to claim 1, wherein
the display control unit causes at least one of image, name, and color associated in advance with a function indicated by the acquired function information, to be displayed on the operation GUI.

5. The transmission-type display device according to claim 1, wherein
content of an operation on the operation GUI and a gesture of the user are associated with each other in advance, and
the display control unit executes an operation on the operation GUI according to the detected gesture of the user.

6. The transmission-type display device according to claim 1, wherein
the function information acquisition unit acquires the function information, triggered by completion of connection between the operation target device and the transmission-type display device.

7. The transmission-type display device according to claim 1, wherein
the display control unit causes the operation GUI to be displayed if the detected gesture is a predetermined gesture.

8. The transmission-type display device according to claim 1, wherein
the display control unit causes the operation GUI to be displayed if a gesture of the user is detected in a display area of the image display unit.

9. The transmission-type display device according to claim 1, wherein
the display control unit causes information related to the function information to be displayed in an area where the operation GUI is not displayed, in the display area of the image display unit.

10. A display control method for a transmission-type display device having a light-transmissive image display unit, the method comprising:
acquiring function information of an operation target device;
causing an operation GUI of the operation target device to be displayed, using the acquired function information;
detecting a predetermined gesture of a user of the transmission-type display device; and
causing the operation GUI to be displayed as superimposed on an external field transmitted through the image display unit and visually recognized, at a display position determined according to a position of the detected gesture.

11. A computer program for achieving a display control method for a transmission-type display device having a light-transmissive image display unit, the computer program causing a computer to achieve functions of:
acquiring function information of an operation target device;
causing an operation GUI of the operation target device to be displayed, using the acquired function information;
detecting a predetermined gesture of a user of the transmission-type display device; and
causing the operation GUI to be displayed as superimposed on an external field transmitted through the image display unit and visually recognized, at a display position determined according to a position of the detected gesture.
